(19) United States
(12) Patent Application Publication
(10) Pub. No.: US 2024/0226719 A1
(43) Pub. Date: Jul. 11, 2024

(54) COMPUTER SYSTEM, GAME SYSTEM, PLAYER TERMINAL, AND GAME EXECUTION CONTROL METHOD

(71) Applicant: Bandai Namco Entertainment Inc., Tokyo (JP)

(72) Inventors: Takeshi INOUE, Tokyo (JP); Sota KAGEYAMA, Tokyo (JP); Tetsunori KAWANOUE, Tokyo (JP); Yusuke NAKAMURA, Tokyo (JP); Yoshinobu OKI, Tokyo (JP); Takashi TANAKA, Tokyo (JP); Kotaro USUI, Tokyo (JP); Kensuke TSUKANAKA, Tokyo (JP); Akihito CHIBA, Tokyo (JP)

(21) Appl. No.: 18/617,881

(22) Filed: Mar. 27, 2024

Related U.S. Application Data
(63) Continuation of application No. PCT/JP2022/028742, filed on Jul. 26, 2022.

(30) Foreign Application Priority Data
Sep. 29, 2021 (JP) 2021-160086

(51) Int. Cl. A63F 13/23

(52) U.S. Cl. CPC A63F 13/23

(57) ABSTRACT

When a server system detects that a first player character and a second player character have entered a given involved situation in a common game space, the server system performs gameplay control to a player terminal of the first player character and a player terminal of the second player character according to gameplay specs of each of the player terminals in the involved situation. As the gameplay control, the server system generates a special game space including an object model of a grade appropriate for implementing a play experience as pleasant as possible with the highest possible quality allowed by the gameplay specs, and generates and displays a game space image and a gameplay image in the special game space.

### CROSS REFERENCE TO RELATED APPLICATIONS

This application is a continuation of International Patent Application No. PCT/JP2022/028742, having an international filing date of Jul. 26, 2022, which designated the United States, the entirety of which is incorporated herein by reference. Japanese Patent Application No. 2021-160086 filed on Sep. 29, 2021 is also incorporated herein by reference in its entirety.

### BACKGROUND OF THE INVENTION

A massively multiplayer online (MMO) game is a typical example of online games. The MMO game uses a known technique allowing computers in various categories to be used as game clients, such as a home-use stationary game device, a portable game device, a personal computer, or a smartphone.

For example, Japanese Unexamined Patent Application Publication No. 2014-73266 discloses a technique for acquiring communication quality information of each game client and performing progress control of a game in a game mode according to the communication quality.

Unfortunately, the technique disclosed in the Japanese Unexamined Patent Application Publication No. 2014-73266 sets the game client with low communication speed (communication environment) to a “text mode”, which restricts direct operation of a player character. In addition, a gameplay screen is simple, and a player needs to operate an update button to display a screen reflecting latest game progress status. With such a conventional technique, the game client with poor communication environment has a play experience of only managing to play the game, and it cannot be said that the game client is having a “pleasant play experience” at all.

In addition to the communication speed, a performance index of the game client for pleasantly playing the online game includes a communication processing ability and a calculation processing ability of the game client itself. Thus, it may be unreasonable to treat the game client differently based on only the communication speed as the index.

### BRIEF DESCRIPTION OF THE DRAWINGS

FIG. 1 is a diagram illustrating a configuration example of a game system.

FIG. 2 is a diagram illustrating an online game provided by the game system.

FIG. 3 is a diagram illustrating fighting play of player characters in an involved situation.

FIG. 4 is a diagram illustrating settings of grades applied to objects disposed in a special game space.

FIG. 5 is a diagram illustrating generation of a gameplay image in the involved situation.

FIG. 6 is a functional block diagram illustrating a functional configuration example of a server system.

FIG. 7 is a diagram illustrating an example of programs and data stored in a server storage section.

FIG. 8 is a diagram illustrating a data configuration example of object initial setting data.

FIG. 9 is a diagram illustrating a data configuration example of display quality selection criteria data.

FIG. 10 is a diagram illustrating a data configuration example of user registration data.

FIG. 11 is a diagram illustrating a data configuration example of game progress management data.

FIG. 12 is a diagram illustrating a data configuration example of involved situation management data.

FIG. 13 is a diagram illustrating a data configuration example of gameplay image management data.

FIG. 14 is a functional block diagram illustrating a functional configuration example of a player terminal.

FIG. 15 is a flowchart illustrating a flow of processing performed by the server system.

FIG. 16 is a flowchart continuing from FIG. 15.

FIG. 17 is a diagram illustrating a system configuration of a game system according to a second embodiment, and responsible parties for generation of a game space image and a gameplay image.

FIG. 18 is a functional block diagram illustrating a functional configuration example of a server system according to the second embodiment.

FIG. 19 is a diagram illustrating an example of programs and data stored in a server storage section according to the second embodiment.

FIG. 20 is a functional block diagram illustrating a functional configuration example of a player terminal according to the second embodiment.

FIG. 21 is a diagram illustrating an example of programs and data stored in a terminal storage section according to the second embodiment.

FIG. 22 is a flowchart illustrating operation of the game system according to the second embodiment, and is the flowchart illustrating flows of processing performed by the server system and the player terminal.

FIG. 23 is a flowchart continuing from FIG. 22.

FIG. 24 is a flowchart continuing from FIG. 23.

### DETAILED DESCRIPTION

The following disclosure provides many different embodiments, or examples, for implementing different features of the provided subject matter. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Further, when a first element is described as being “connected” or “coupled” to a second element, such description includes embodiments in which the first and second elements are directly connected or coupled to each other, and also includes embodiments in which the first and second elements are indirectly connected or coupled to each other with one or more other intervening elements in between.

In accordance with one of some embodiments, there is provided a computer system comprising at least one processor or circuit comprising:
a common game space setting section configured to set a common game space that can be shared by a plurality of player characters including a first player character related to a first player terminal and a second player character related to a second player terminal having gameplay specs inferior to gameplay specs of the first player terminal;
an involved situation detection section configured to detect that the first player character and the second player character have entered a given involved situation in the common game space; and
a gameplay control section configured to perform first gameplay control set according to the gameplay specs of the first player terminal to the first player terminal and second gameplay control set according to the gameplay specs of the second player terminal to the second player terminal upon detection by the involved situation detection section.

The “involved situation” is a situation where the first player character and the second player character largely affect each other with respect to a game progress status or a game result in the common game space. For example, in a player-versus-player battle royale fighting action game, an encounter corresponds to the involved situation. If a common event occurs in relation to a plurality of players acting together, this event also corresponds to the involved situation. The common event is, for example, an event for cooperating play, conversation with a special NPC considered as a highlight in game progress, or acquisition of a special item. It can be said that play in the involved situation is a core of the gameplay in the online game. Accordingly, if a play experience is provided using the gameplay specs of the player terminal as much as possible in the play in the involved situation, a pleasant play experience can be provided.

According to the disclosure, in some embodiments, when the player characters have entered the given involved situation in the common game space, special gameplay control (the first gameplay control and the second gameplay control) according to the gameplay specs can be performed for each of the player terminals of the player characters. The gameplay specs can be, for example, any of a communication processing ability, a calculation processing ability, a type of a mounted operating system (OS), and communication speed.

Furthermore, according to the disclosure, the same gameplay control is not necessarily performed to all the player terminals of the player characters in the involved situation. In the disclosure, the gameplay control according to the gameplay specs of each of the player terminals is performed. With the player terminal having high gameplay specs, a more pleasant play experience with higher quality can be implemented using surplus capacity. That is, it is possible to provide a pleasant play experience according to the various gameplay specs of game clients.

A second disclosure is the computer system, wherein the at least one processor or circuit further comprises a special game space setting section configured to set a special game space where the first player character and the second player character can exist upon the detection by the involved situation detection section, and wherein the gameplay control section performs the first gameplay control in the special game space to the first player terminal and the second gameplay control in the special game space to the second player terminal upon the detection by the involved situation detection section.

According to the disclosure, in some embodiments, the computer system can perform the gameplay control related to the involved situation using the special game space. Preparing the special game space allows implementation of the gameplay control for the first player terminal and the second player terminal without affecting objects outside the special game space.

A third disclosure is the computer system, wherein the special game space setting section sets the special game space in the common game space such that a player character existing outside the special game space can see the special game space.

According to the disclosure, in some embodiments, setting the special game space as a limited area in the common game space allows a player other than players involved in the involved situation to see what is happening in the involved situation in a gameplay image. In particular, a state in the special game space can also be seen in the gameplay image displayed on the player terminal of the player character that is not involved in the involved situation. As a result, the common game space and the special game space are not separated in a game world, and the players can feel that these spaces are the same one game world.

A fourth disclosure is the computer system, wherein the involved situation is a situation where the first player character and the second player character satisfy a given encounter condition in the common game space.

According to the disclosure, in some embodiments, an encounter between the player characters in the common game space is considered as the involved situation.

A fifth disclosure is the computer system, wherein the gameplay control section performs control for restoring gameplay control before the detection from the gameplay control according to the detection when a given end condition is satisfied after the detection by the involved situation detection section.

According to the disclosure, in some embodiments, the gameplay control is temporarily performed due to the detection of the involved situation, and thus resource consumption related to the relevant gameplay control can be temporary. In addition, a stage effect that gives a special feeling to occurrence of the involved situation can be obtained.

A sixth disclosure is the computer system,
wherein the gameplay control includes controlling a display quality of a game image on each of the player terminals, and
wherein the gameplay control section includes a terminal image control section configured to perform first terminal image control for making the game image on the first player terminal have a first display quality, and second terminal image control for making the game image on the second player terminal have a second display quality that is inferior to the first display quality upon the detection by the involved situation detection section.

The “display quality” is determined by an image quality, an image size (a number of pixels included in the image; Display resolution can be increased on the player terminal as the image size increases.), a display refresh rate, a number of colors, a dynamic range of a color space, or the like of the gameplay image indicating a state of the common game space or the special game space.

The “terminal image control” corresponds to various types of control required for displaying the gameplay image on the player terminal. For example, the control includes 1) control for selecting an object model of a grade appropriate for implementing the display quality and disposing the object model in the game space that becomes a base for rendering, 2) control for selecting a motion of a grade appropriate for implementing the display quality, and moving the object model, and 3) rendering the game space image in an image size and a number of colors appropriate for implementing the display quality.

According to the disclosure, in some embodiments, the computer system can separately perform the terminal image control for each of the first player terminal and the second player terminal. As a result, it is possible to provide a play experience as pleasant as possible with the highest possible quality allowed by the gameplay specs of each of the first player terminal and the second player terminal.

A seventh disclosure is the computer system, wherein the gameplay control includes controlling an object displayed in the game image on each of the player terminals, and wherein the terminal image control section performs the first terminal image control for making a class of the object displayed in the game image on the first player terminal a first class, and the second terminal image control for making the class of the object displayed in the game image on the second player terminal a second class that is inferior to the first class in quality.

According to the disclosure, in some embodiments, the computer system can control models of the objects such as a character used for displaying the gameplay image of each of the first player terminal and the second player terminal by classifying the models in a plurality of grades. For example, for the player terminal having the high gameplay specs, the computer system provides a pleasant play experience and a good gameplay image using the models having rich details and a large number of polygons. On the contrary, for the player terminal having the low gameplay specs, the computer system ensures the pleasant play experience using the models having a fewer number of polygons even if an appearance of the player character is degraded. In this way, it is possible to keep balance between the quality and the pleasantness of the play experience such as play operation and a display image quality according to the gameplay specs.

An eighth disclosure is the computer system, wherein the gameplay control includes controlling an allowed operation input type on each of the player terminals, and wherein the gameplay control section includes a terminal operation type control section configured to perform first terminal operation type control for making the allowed operation input type on the first player terminal a first operation type, and a second terminal operation type control for making the allowed operation input type on the second player terminal a second operation type that includes a fewer number of operation input types than the first operation type, upon the detection by the involved situation detection section.

According to the disclosure, in some embodiments, the computer system can separately manage allowed input operation on the first player terminal and allowed input operation on the second player terminal. As a result, it is possible to adjust an influence given to the gameplay by an advantage or a disadvantage related to operability between the player terminal having the high gameplay specs and the player terminal having the low gameplay specs.

A ninth disclosure is the computer system, wherein the plurality of player characters that share the common game space include a third player character related to a third player terminal having the gameplay specs inferior to the gameplay specs of the second player terminal, wherein the involved situation detection section detects that the first player character and the third player character have entered the involved situation, and wherein, upon the detection of the involved situation between the first player character and the third player character by the involved situation detection section, the gameplay control section performs third gameplay control set according to the gameplay specs of the third player terminal to the third player terminal.

According to the disclosure, in some embodiments, the computer system can perform play control according to superiority or inferiority of the gameplay specs of the player terminals.

A tenth disclosure is the computer system, wherein the at least one processor or circuit further comprises a notification display control section configured to make notification performed on each of the player terminals related to the player characters detected by the involved situation detection section to notify that the gameplay control according to the detection is performed.

According to the disclosure, in some embodiments, the computer system can notify the players involved in the involved situation that the special gameplay control is being performed.

An eleventh disclosure is the computer system, wherein the at least one processor or circuit further comprises a reinforcement control processing section configured to perform reinforcement control processing of enhancing a parameter value of the second player character when the gameplay control according to the detection by the involved situation detection section is performed by the gameplay control section.

According to the disclosure, in some embodiments, the computer system can adjust an influence given to the gameplay by the superiority or the inferiority of the gameplay specs of the player terminals.

A twelfth disclosure is the computer system, wherein the at least one processor or circuit further comprises a storage section configured to store a setting of approval/disapproval of switching to the second gameplay control as an individual setting of each of the player terminals, and wherein the gameplay control section performs the first gameplay control to the second player terminal when the setting of the approval/disapproval related to the second player terminal is a setting indicating the disapproval.

According to the disclosure, in some embodiments, the player can select whether to approve or disapprove the application of the second gameplay control to his/her player terminal.

A thirteenth disclosure is the computer system, wherein the gameplay control includes control for sending data required for generating a gameplay image to each of the player terminals to have the gameplay image generated on the player terminal, and control for sending the gameplay image generated on the computer system to each of the player terminals to have the gameplay image displayed on the player terminal.

According to the disclosure, in some embodiments, the computer system can implement the gameplay control by selectively performing a method by which the gameplay image is generated on the player terminal based on the data sent from the computer system and a method by which the gameplay image generated by the computer system is displayed on the player terminal of a recipient.

A fourteenth disclosure is the computer system, wherein the gameplay control includes control for sending data required for generating a gameplay image to each of the player terminals to have the gameplay image generated on the player terminal.

According to the disclosure, in some embodiments, some of calculations related to the gameplay control are performed by the player terminal, so that a load of the computer system can be reduced.

As a fifteenth disclosure, the game system wherein the computer system as defined above and the player terminals may be configured to communicate with each other.

A sixteenth disclosure is a player terminal configured to communicate with a computer system that provides an online game that a player operates a player character using the player terminal to enjoy gameplay in a common game space, wherein the player terminal may become any one of a first player terminal having relatively high gameplay specs and a second player terminal having relatively low gameplay specs, wherein the computer system comprises an involved situation detection section configured to detect that a first player character related to the first player terminal and a second player character related to the second player terminal have entered a given involved situation in the common game space, and a gameplay control section configured to perform first gameplay control set according to the gameplay specs of the first player terminal to the first player terminal and second gameplay control set according to the gameplay specs of the second player terminal to the second player terminal upon detection by the involved situation detection section, and wherein the player terminal performs control for generating and displaying a gameplay image based on data required for generating the gameplay image received from the computer system.

According to the disclosure, in some embodiments, it is possible to implement the player terminal that appreciates advantageous effects of the computer system.

A seventeenth disclosure is a game execution control method executed by a computer system, the method comprising: setting a common game space that can be shared by a plurality of player characters including a first player character related to a first player terminal and a second player character related to a second player terminal having gameplay specs inferior to gameplay specs of the first player terminal; detecting that the first player character and the second player character have entered a given involved situation in the common game space; and performing first gameplay control set according to the gameplay specs of the first player terminal to the first player terminal and second gameplay control set according to the gameplay specs of the second player terminal to the second player terminal upon detection of the involved situation.

According to the disclosure, in some embodiments, it is possible to implement the game execution control method that achieves the same advantageous effects as those of the disclosure related to the computer system described above.

Exemplary embodiments are described below. Note that the following exemplary embodiments do not in any way limit the scope of the content defined by the claims laid out herein. Note also that all of the elements described in the present embodiment should not necessarily be taken as essential elements

Hereinafter, examples of embodiments of the present disclosure are described. However, modes to which the present disclosure is applicable are not limited to the following embodiments.

### First Embodiment

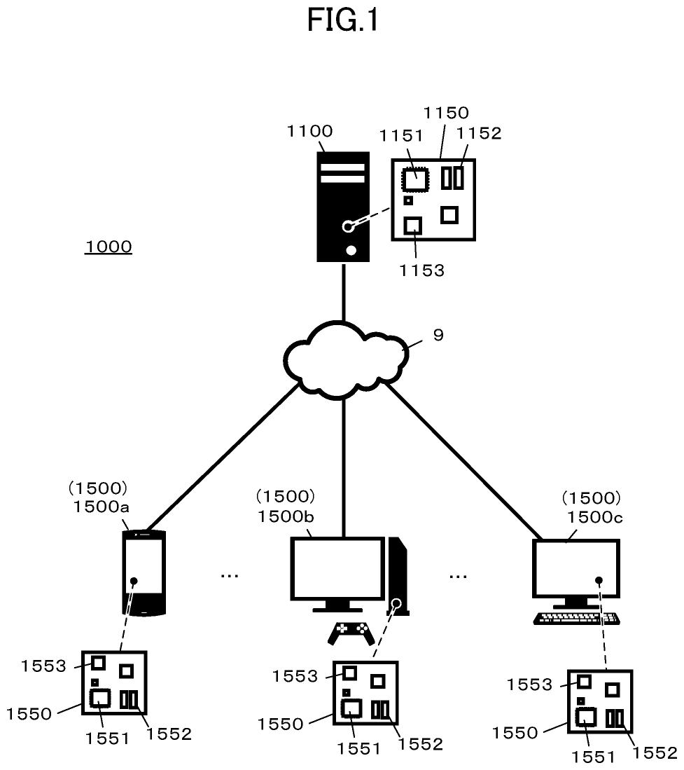

FIG. 1 is a diagram illustrating a configuration example of a game system.

A game system 1000 includes a server system 1100 and player terminals 1500 (1500a, 1500b, . . . ) of respective players that can communicate with the server system 1100. The game system 1000 is a system for implementing an online game using the player terminals 1500 as man-machine interfaces. FIG. 1 illustrates only three player terminals 1500. However, a number of player terminals 1500 are not limited in actual system operation.

The server system 1100 and the player terminals 1500 can perform data communication via a network 9, and the player terminals 1500 can also perform data communication with each other via the network 9.

The network 9 means a communication channel capable of data communication. The network 9 inclusively means a communication network such as a local area network (LAN) using a private line (a private cable) for direct connection or Ethernet (registered trademark), a telecommunication network, a cable network, and an Internet. A communication method may be a cable communication method or a wireless communication method.

The server system 1100 is a computer system that includes, for example, a main body device, a keyboard, a touch panel, a storage, and a control board 1150 mounted in the main body device.

The control board 1150 includes a microprocessor of various types such as a central processing unit (CPU) 1151, a graphics processing unit (GPU), or a digital signal processor (DSP), an IC memory 1152 of various types such as a VRAM, a RAM, or a ROM, and a communication device 1153. The control board 1150 may be implemented partially or entirely by an application specific integrated circuit (ASIC), a field-programmable gate array (FPGA), or a system on a chip (SoC).

Through a calculation process performed by the control board 1150 based on predetermined programs and data, the server system 1100 implements a user management function for managing information related to user registration or the like and a game management function for allowing users to play an online game.

The server system 1100 is illustrated as including only one server device. However, the server system 1100 may be implemented by a plurality of devices working together. For example, the server system 1100 may be configured such that a plurality of blade servers are connected together via an internal bus in a data communicable manner to share the functions. Hardware included in the server system 1100 may be installed anywhere. The server system 1100 may be configured such that a plurality of independent servers installed at separate places perform data communication via the network 9 to function as the server system 1100 as a whole.

Each of the player terminals 1500 (1500a, 1500b, . . . ) is a computer system used by a user to play the game using the game system 1000. The player terminal 1500 is also an electronic apparatus (electronic device) that accesses the server system 1100 or other player terminals 1500 via the network 9. That is, the player terminal 1500 functions as a man-machine interface in the game system 1000.

The player terminal 1500 includes an operation input device (e.g., a keyboard, a touch panel, a game controller, or a mouse), an image display device (e.g., a video monitor, a touch panel, or a head-mounted display), and a control board 1550.

The control board 1550 includes a microprocessor of various types such as a CPU 1551, a GPU, or a DSP, an IC memory 1552 of various types such as a VRAM, a RAM, or a ROM, a communication module 1553 that connects to the network 9. These elements mounted on the control board 1550 are electrically connected with each other via a bus circuit or the like to read/write data and exchange signals. The control board 1550 may be partially or entirely implemented by an ASIC, an FPGA, or an SoC. The control board 1550 stores programs and various types of data for implementing functions of the player terminal in the IC memory 1552.

According to the present embodiment, the player terminal 1500 downloads the programs and various types of setting data from the server system 1100. Alternatively, the player terminal 1500 may read the programs and data from a storage medium such as a memory card additionally provided.

The player terminal 1500 may be any computer system. For example, the player terminal 1500 may be a smartphone, a wearable computer such as a smart watch, a portable game device, a home-use stationary game device, a tablet computer, a personal computer, or an arcade game apparatus. When a plurality of electronic devices, such as a combination of a smartphone and a smartwatch capable of establishing a communication connection with the smartphone, are communicably connected to perform a single function, the plurality of electronic devices may be considered as a single player terminal 1500.

In actual operation, player terminals 1500 (1500a, 1500B, . . . ) of various models in various categories, such as a smartphone, a home-use game device, or a personal computer, are used at the same time. Accordingly, hardware specs (e.g., CPU specs, mounted memory capacity, graphic board specs, communication module specs, bus specs, or display specs) and software specs (e.g., OS specs, or a communication module) also vary. The calculation processing ability and the communication processing ability of a single player terminal 1500 depend on the hardware specs and the software specs.

Furthermore, actual circumstances of the network 9 that communicably connects each of the player terminals 1500 and the server system 1100, i.e., the communication environments, also vary. For example, there are various elements related to the communication quality such as whether the connection is made via a base station of a mobile phone to which the player terminal 1500 is wirelessly connected, whether the connection is made by wire, a degree of delay (including transmission delay, propagation delay, etc.), a bandwidth, or a degree of packet loss. The elements vary depending on the player terminals 1500. As a result, effective communication speed when each of the player terminals 1500 communicates with the server system 1100 varies.

These factors that affect the gameplay performed on each of the player terminals 1500 (any of the communication processing ability of the player terminal 1500, the calculation processing ability of the player terminal 1500, and the communication speed between the player terminal 1500 and the server system) are generally called “gameplay specs”.

The “gameplay specs” include the hardware specs (e.g., CPU specs, mounted memory capacity, graphic board specs, communication module specs, bus specs, or display specs), the software specs (e.g., OS specs, or a communication module), line speed, a line type, or the like.

Information on the gameplay specs of each of the player terminals 1500 is acquired and stored by the server system 1100 before the game starts. The server system can acquire the hardware specs and the software specs of the gameplay specs of the player terminal 1500 using a system information collection function from a remote place according to a model or an OS version. The communication speed can be measured by performing a sending/receiving test of dummy data.

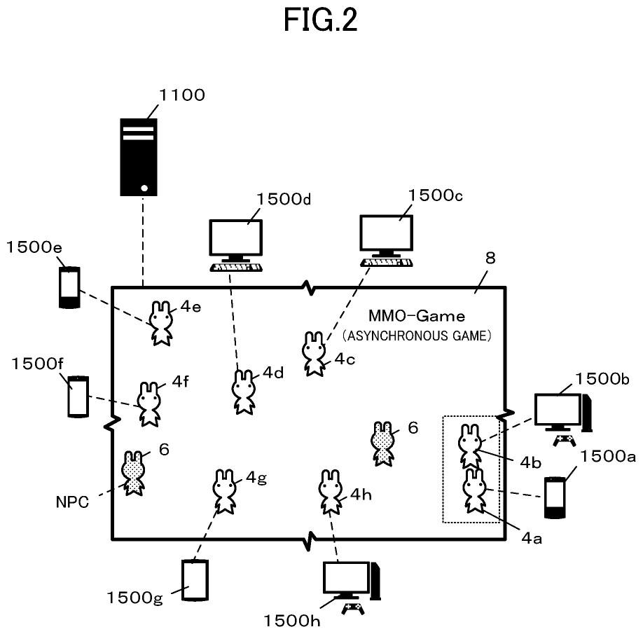

FIG. 2 is a diagram illustrating an online game provided by the game system 1000. The online game provided by the game system 1000 is an MMO game with a theme of a battle royale based on encounter battles.

A user accesses the server system 1100 or a predetermined website managed by the server system 1100 using his/her player terminal 1500, and takes a predetermined user registration procedure to be qualified as a player. Then, the user takes a predetermined sign-in procedure using a unique user account (sign-in name) set at the registration so that the player terminal 1500 of the user is incorporated into the game system 1000 and set in a system-online state. The player terminal 1500 can be withdrawn from the system and put in a system-offline state by taking a predetermined sign-out procedure. The user performs a predetermined game login procedure (hereinafter referred to as login) in the system-online state to play the online game. The user may be automatically set in a login state when the user becomes the system-online state.

Each of the player terminals 1500 (1500a, 1500b, . . . ) is assigned with a player character 4 (4a, 4b, . . . ). The player character 4 is disposed in a single common game space 8 along with a non player character (NPC) 6 and background objects forming a game world. In particular, data of various types of objects is stored in the common game space 8, and the data is updated by coordinate transformation along with motion control of the objects.

The player can customize his/her player character 4 before starting the game. In particular, the player can select one of several basic character types as a base, and customize it by providing equipment suitable for a fighting style that the player prefers. The player starts the gameplay watching a gameplay image overlooking the common game space 8 displayed on the player terminal 1500. An area that the player can overlook may be the entire common game space 8, or only a limited area with the player character 4 as a reference.

The player operates and moves his/her player character 4 while watching the gameplay image and considering a geographical feature and timing appropriate for his/her preferred fighting style. Then, the player makes his/her player character 4 approach another player character to start a battle so as to be a last survivor. The battle between the player characters 4 who have encountered each other in the common game space 8 is a core part of play elements of the online game, and, for the players in the battle, it is an important situation where the players are involved with each other to affect play performances and game experiences.

The server system 1100 manages game progress, such as traveling or motion of the objects disposed in the common game space 8, or hit determination, as an asynchronous game.

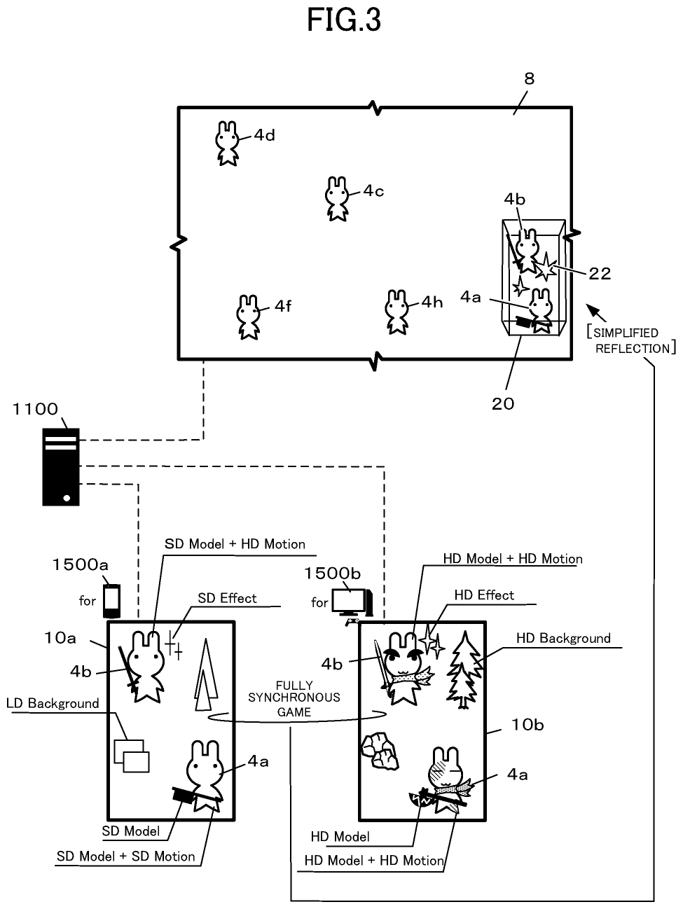

When a plurality of player characters 4 close to each other satisfy a given involved situation determination condition in the common game space 8, the server system 1100 considers that these player characters 4 have entered an “involved situation”. That is, the server system 1100 detects that the player characters have entered the involved situation, that is, occurrence of the involved situation. In an example in FIG. 3, a player character 4a and a player character 4b are in the involved situation.

The “involved situation determination condition” can be set as appropriate depending on game content such as that a first player character and a second player character 4 satisfy a given encounter condition in the common game space 8. In the present embodiment, the condition may be that “another player character comes in an attack range of a player character”, or “a player character locks on to another player character (sets another player character as an automatic tracking target of attack aiming)”. Furthermore, the condition may also include “approval for starting a battle” by one or both of the player characters.

When the server system 1100 detects the occurrence of the involved situation, the server system 1100 performs progress control of fighting play between these player characters 4 in the involved situation as a fully synchronous game along with the game progress control in the common game space 8. This fighting play is hereinafter referred to as “involved-situation play”.

FIG. 3 is a diagram illustrating the involved-situation play. The server system 1100 generates a special game space 10 for the involved-situation play. A gameplay image of the involved-situation play is generated based on this special game space 10. The involved-situation play is the gameplay from a start of the involved situation to an end of the involved situation. Once the involved situation occurs, a display of the gameplay image generated based on the common game space 8 is switched to a display of the gameplay image generated based on the special game space 10 on the player terminal 1500 (hereinafter referred to as an “involved terminal”) of each of the player characters 4 in the involved situation.

The special game space 10 is generated based on a reference position of a representative point related to the detected involved situation (e.g., a halfway point between the player characters 4 in the involved situation). The special game space 10 is generated in the common game space 8 as a limited area in the common game space 8 and a space copying the limited area. The special game space 10 is shared between the players using the involved terminals. However, qualities of images displayed on the involved terminals differ depending on the gameplay specs of the involved terminals.

A number of special game spaces 10 (10a, 10b, . . . ) to be prepared corresponds to a number of types of the gameplay specs of the involved terminals. In the example in FIG. 3, the gameplay specs of a player terminal 1500a (second player terminal) of one of the involved terminals is inferior to the gameplay specs of a player terminal 1500b (first player terminal) of another one of the involved terminals, and thus two special game spaces 10 are prepared.

Since the involved-situation play is one of the core parts of the online game according to the present embodiment, it should provide a play experience as pleasant as possible with the highest possible quality as the fully synchronous game.

When prioritizing an image quality as a quality of the play experience, “detailed modeling”, “realistic shading display”, and “detailed motion expressions” are desired. However, in order to implement these elements, a high calculation processing ability, a high image display ability, and high communication speed are required. If the player terminal 1500 whose gameplay specs are not high enough is forced to implement these elements, calculation processing cannot follow regular frame image update, and thus the player character 4 in the gameplay image moves jerkily and smoothness of motion is lost. As a result, operational response also deteriorates. This can deteriorate the quality of the play experience.

In order to implement the “pleasant play experience” for the player terminal 1500a (second player terminal) having the inferior gameplay specs, a load related to the calculation processing, a load related to the image display, and a load related to the communication need to be reduced. However, for the player terminal 1500b having the superior gameplay specs, it is desired to utilize its high abilities as much as possible to provide the play experience as pleasant as possible with the highest possible quality. Assume that a single game space similar to the common game space 8 is prepared. If the game space is made to suit the gameplay specs of one of the player terminals 1500, the “quality of the play experience” and the “pleasant play experience” are impaired for another one of the player terminals.

Therefore, the server system 1100 prepares the special game space 10 (10a, 10b) for each type of the gameplay specs. The server system 1100 uses the same types of objects, such as the player characters 4 (4a, 4b), backgrounds, items, or effect displays, but changes object models or grades of the objects for each of the special game spaces 10.

A plurality of grades are prepared for data used for arrangement or control of the various types of objects such as the player character 4. The present embodiment is based on an example including three grades of a low definition (LD), a standard definition (SD), and a high definition (HD). However, the grade may be divided more finely.

A number of vertexes and a number of polygons included in the object model are smaller in the lower grade, and a data size is also smaller. It is possible to set a grade in which the number of vertexes and the number of polygons are zero, that is, the object is not actually disposed in the game space. A number of skins and a number of colors of texture data to be applied to the object model are smaller in the lower grade, and a data size is also smaller. As for motion data to be applied to the object model, the motion becomes simpler in the lower grade, and a data size is smaller.

That is, expression of details of a target to be represented by the object deteriorates as the grade lowers. Although the quality of the play experience is lower than the quality in the higher grade, the “pleasant play experience” can be implemented. Meanwhile, in the common game space 8, the grades of the objects can be set as appropriate. However, since it is preferable to uniformly control the common game space 8 as a solo game space accepting the player terminals 1500 of various gameplay specs, the grades are preferably set to the LD or the SD.

In the example in FIG. 3, in the special game space 10a for the player terminal 1500a having the inferior gameplay specs, the objects such as the player character 4 (4a, 4b), the background, the item, or the effect display are set to the SD grade. On the contrary, in the special game space 10b for the player terminal 1500b having the superior gameplay specs, the objects such as the player character 4 (4a, 4b), the background, the item, or the effect display are set to the HD grade.

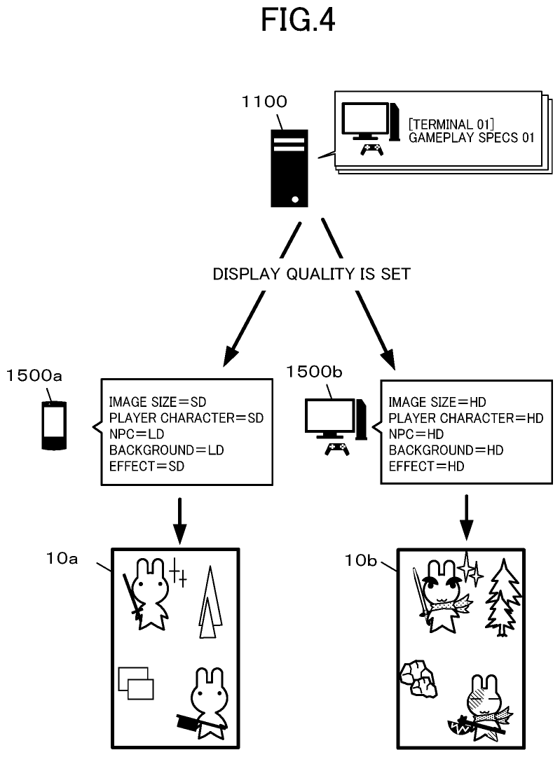

FIG. 4 is a diagram illustrating settings of the grades applied to the objects disposed in the special game space 10. The server system 1100 sets, for each of the involved terminals, the “display quality” suitable for providing the play experience as pleasant as possible with the highest possible quality on each of the involved terminals in the involved-situation play based on information on the gameplay specs of each of the player terminals 1500 that has been acquired beforehand.

A plurality of types of the “display quality” are prepared according to differences in settings of an image size of a game space image (rendering image) generated from the special game space 10 and the grade to be applied to each of categories of the objects disposed in the special game space 10 (e.g., the player character 4, the NPC 6, the background, or the effect). The server system 1100 selects any of the plurality of types of the display quality for each of the involved terminals and associates it with the involved terminal.

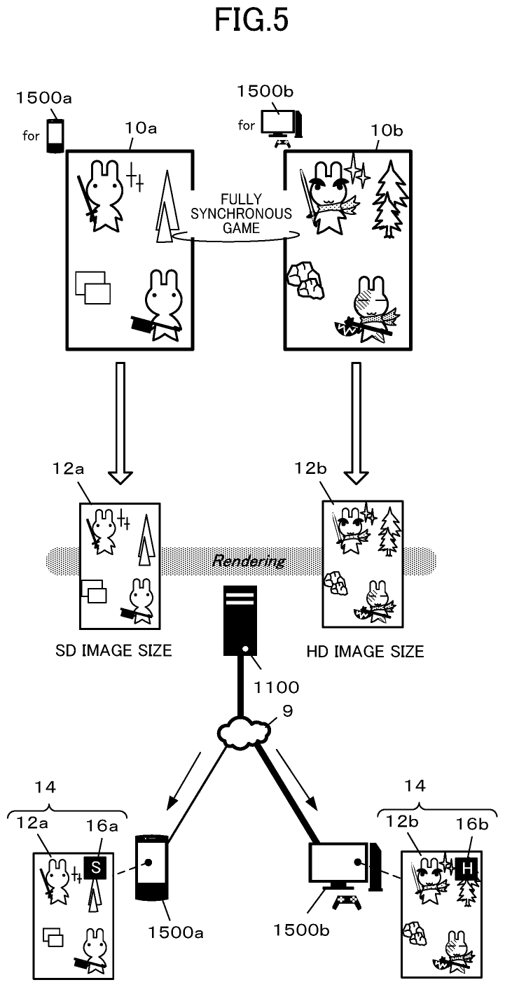

FIG. 5 is a diagram illustrating generation of the gameplay image in the involved situation.

After selecting the type of the display quality for each of the involved terminal, the server system 1100 prepares the special game space 10 (10a, 10b) for each type of the display quality, and performs progress control of the involved-situation play as the fully synchronous game such that the special game spaces 10 (10a, 10b) fully synchronize with each other.

The server system 1100 renders a game space image 12 based on each of the special game spaces 10 in an image size specified by the display quality. Then, the server system 1100 generates a gameplay image 14 (display content that the player watches during the gameplay; a play screen) including the game space image 12, and generates and sends data for displaying the gameplay image 14 on the involved terminal for each of the involved terminals. Meanwhile, the gameplay image 14 includes a notification display 16 indicating which type of the display quality is associated with the involved terminal in addition to the game space image 12.

Referring back to FIG. 3, a state of the special game space 10 is reflected to the common game space 8. First, an object of an area display 20 indicating an area of the special game space 10 is disposed in the common game space 8. In addition, a state of the object model of each of the player characters 4 (4a, 4b, . . . ) in the involved-situation play is reflected to the object model of the player character 4 in the involved situation in the common game space 8. This is called reflection control. While performing the progress control of the involved-situation play, the server system 1100 performs the reflection control such that a progress control result is reflected as a simplified video image of a state in the special game space 10 seen from the outside. Simplified effects 22 such as flashes presenting attacks, sparks or explosive smoke presenting occurrence of damage in the involved-situation play are also subject to the reflection control.

Although the common game space 8 and the special game space 10 have small differences due to the differences in the grades or the like of the object models disposed therein, essential states of the common game space 8 and the special game space 10 are the same. Conceptually, it can be rephrased that the special game space 10 is set within the common game space 8 such that player characters (player characters not in the relevant involved situation in the common game space 8) existing outside the special game space 10 can see inside the special game space 10.

Thus, players of uninvolved player characters 4 (4c, 4d, . . . ) other than the player characters 4 (4a, 4b) in the involved situation can see the player characters 4 (4a, 4b) in the involved situation having a battle in the gameplay image based on the common game space 8.

Of course, since only the player characters 4 (4a, 4b) in the involved situation can participate in the involved-situation play, the uninvolved player characters can only see the battle. However, this can effectively produce a “feeling” as if a battle royale is happening in the single common game space 8.

When a situation end condition (e.g., victory or defeat of the battle has been decided, a time limit has passed, or both sides have run out of bullets) that the involved-situation play is considered to have ended is satisfied, the involved-situation play is terminated. Data of the special game space 10 related to this is deleted.

Treatment of the player terminals 1500 (1500a, 1500b, . . . ) as the involved terminals is terminated, and control of the player characters 4 (4a, 4b) that were in the involved situation is returned to the control in the asynchronous game in the common game space 8 which is a state before entering the involved situation.

In this manner, the server system 1100 performs the gameplay control to implement the display quality set according to the gameplay specs of each of the involved terminals for the involved-situation play that is one of the core parts of the online game while using the image based on the common game space 8 as a basic gameplay image.

As a result, the game system 1000 can provide the pleasant play experience according to the relevant game client for each of the game clients having different gameplay specs.

When a third player terminal 1500, a fourth player terminal 1500, and more are included in the involved situation (e.g., in a case of a two-on-two team battle style, or a case allowing a three-cornered battle), a third player terminal 1500 and a fourth player terminal 1500 are considered to be in the same involved situation and treated similarly.

Next, a functional configuration is described.

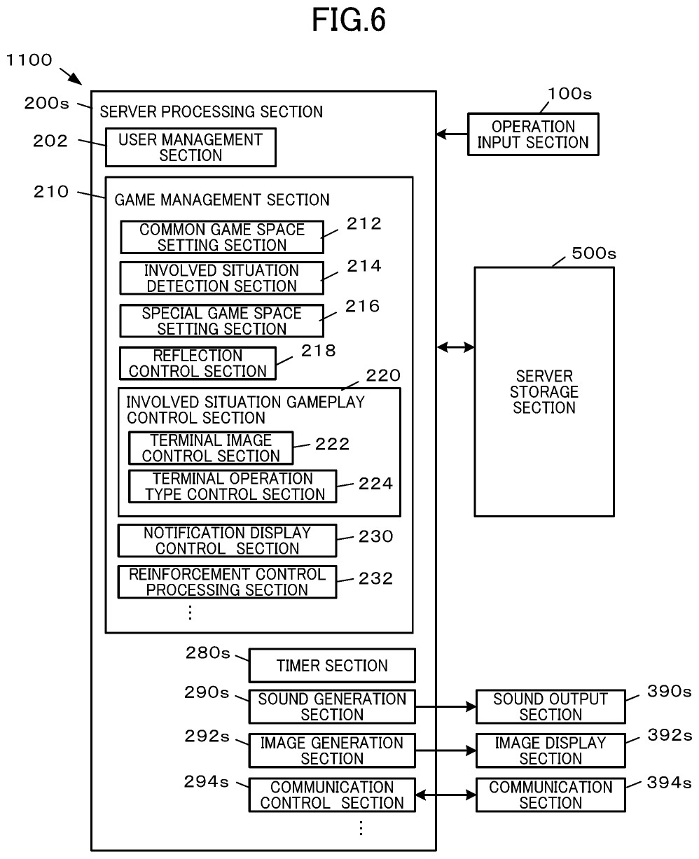

FIG. 6 is a functional block diagram illustrating a functional configuration example of the server system 1100.

The server system 1100 includes an operation input section 100s, a server processing section 200s, a sound output section 390s, an image display section 392s, a communication section 394s, and a server storage section 500s.

The operation input section 100s is a means for inputting various types of operation for management of the server system 1100. For example, the operation input section 100s corresponds to a keyboard, a touch panel, and a mouse.

The server processing section 200s is implemented, for example, by a processor that is a calculation circuit such as a CPU, a GPU, an ASIC, or an FPGA and an electronic component such as an IC memory. The server processing section 200s performs input/output control of data to/from functional sections including the operation input section 100s and the server storage section 500s. The server processing section 200s performs various calculation processing based on predetermined programs and data, operation input signals from the operation input section 100s, data received from the player terminal 1500, or the like to comprehensively control the operation of the server system 1100.

The server processing section 200s includes a user management section 202, a game management section 210, a timer section 280s, a sound generation section 290s, an image generation section 292s, and a communication control section 294s. Other functional sections may be included as appropriate, of course.

The user management section 202 performs processing related to a user registration procedure, and manages various types of information associated with a user account. In particular, the user management section 202 performs issuing a unique user account to a registered user, managing personal information for each user account, managing saved data related to the play of an online game, or the like.

The game management section 210 performs various control for allowing the user to play a given online game on the player terminal 1500. In particular, the game management section 210 performs various processing related to game progress control of the online game. For example, the game management section 210 performs determination of initial arrangement of various types of objects such as the player character 4, or the NPC 6 in the common game space 8, motion control of the player character 4 according to the operation input by the player, motion control of the NPC 6, collision determination of the objects, hit determination of the attack, damage determination and damage reflection, change of ability parameter values of the player character 4 and the NPC 6, generation of events, calculation of game results, or determination of an end of the game or the involved situation.

The game management section 210 includes a common game space setting section 212, an involved situation detection section 214, a special game space setting section 216, a reflection control section 218, an involved situation gameplay control section 220, a notification display control section 230, and a reinforcement control processing section 232.

The common game space setting section 212 sets the common game space 8 in a three-dimensional virtual space, and disposes various types of objects that appear in the game such as the player character 4. The common game space setting section 212 also controls positions, postures, shapes, sizes, appearances, and elimination of these objects according to the game progress control result.

The involved situation detection section 214 detects that the first player character related to the first player terminal and the second player character related to the second player terminal have entered the given involved situation in the common game space 8. Of course, when the player terminals 1500 in the system-online state include a third player terminal having the gameplay specs inferior to the gameplay specs of the second player terminal 1500, the involved situation detection section 214 can detect that the first player character and a third player character related to the third player terminal 1500 have entered the involved situation.

When the involved situation detection section 214 detects the involved situation, the special game space setting section 216 sets a special game space 10 where the first player character and the second player character in the involved situation can exist.

The reflection control section 218 performs control for reflecting the state of the special game space 10 to the common game space 8 so that the player characters existing outside the special game space can see the special game space. In particular, the reflection control section 218 (1) sets objects of the area display 20 and the simplified effect 22, and (2) performs control for reflecting the game progress result related to the involved situation to the objects of the first player character 4 and the second player character 4 that have entered the involved situation in the common game space 8 (see FIG. 3).

Above-described (2) is described in detail. The player characters 4 that have entered the involved situation exist both in the common game space 8 and the special game space 10 though the grades of the object models or the like differ. Accordingly, the reflection control section 218 performs control for conforming the state of each of the object models in the common game space 8 to the state of each of the object models in the special game space 10 as the progress control result of the involved-situation play. When the server system 1100 receives operation input information (or information on an operation command determined depending on the operation input) from the player terminal 1500 that has become the involved terminal, the server system 1100 performs the progress control of the involved-situation play. Meanwhile, the server system 1100 refers to progress control data of the involved situation at a given cycle, and performs control for conforming the state of the object model in the common game space 8 to the state of the object model in the special game space 10.

When the involved situation detection section 214 detects the involved situation, the involved situation gameplay control section 220 performs first gameplay control set according to the gameplay specs of the first player terminal to the first player terminal, and second gameplay control set according to the gameplay specs of the second player terminal to the second player terminal.

In particular, when the involved situation detection section 214 detects the involved situation, the involved situation gameplay control section 220 performs the first gameplay control in the special game space 10 to the first player terminal and the second gameplay control in the special game space 10 to the second player terminal as the gameplay control in the special game space 10. Then, the involved situation gameplay control section 220 performs control for sending data required for generating the gameplay image to the player terminal of each of the player characters in the involved situation to have the gameplay image generated on the player terminal.

However, the involved situation gameplay control section 220 performs control for storing a setting of approval/disapproval of switching to the second gameplay control as an individual setting of each of the player terminals 1500. When the setting of the approval/disapproval related to the second player terminal indicates the disapproval, the involved situation gameplay control section 220 performs the first gameplay control to the second player terminal.

Furthermore, when the player terminals 1500 in the system-online state include the third player terminal having the gameplay specs inferior to the gameplay specs of the second player terminal 1500, the involved situation gameplay control section 220 performs further control. That is, when the involved situation detection section 214 detects that the first player character and the third player character have entered the involved situation, the involved situation gameplay control section 220 performs third gameplay control set according to the gameplay specs of the third player terminal to the third player terminal.

When a given end condition is satisfied after the involved situation detection section 214 detects the involved situation, the involved situation gameplay control section 220 performs control for restoring the gameplay control before the detection in place of the gameplay control according to the detection.

The involved situation gameplay control section 220 includes a terminal image control section 222 and a terminal operation type control section 224.

When the involved situation detection section 214 detects the involved situation, the terminal image control section 222 performs first terminal image control for making the gameplay image on the first player terminal have a first display quality, and second terminal image control for making the gameplay image on the second player terminal have a second display quality that is inferior to the first display quality.

In particular, as the first terminal image control, the terminal image control section 222 performs control for making a class (grade) of the object displayed in the gameplay image on the first player terminal a first class. Furthermore, as the second terminal image control, the terminal image control section 222 performs control for making the class of the object displayed in the gameplay image on the second player terminal a second class that is inferior to the first class in quality (see FIG. 4). In FIGS. 3 and 4, the player terminal 1500a corresponds to the second player terminal, and the gameplay specs of the player terminal 1500a are inferior to the gameplay specs of the player terminal 1500b of the first player terminal. Accordingly, in the special game space 10a, the gameplay image is displayed with the quality simpler than the quality in the special game space 10b.

When the involved situation detection section 214 detects the involved situation, the terminal operation type control section 224 performs first terminal operation type control for making allowed types of the operation input on the first player terminal a first operation type, and a second terminal operation type control for making the allowed types of the operation input on the second player terminal a second operation type that includes a fewer number of types of the operation input than the first operation type.

The types of the operation input that are reduced may be automated, or omitted in the first place. Furthermore, a number of actions required for one operation type may be made different. For example, with regard to an operation for selecting a bullet type to be fired from a gun carried by the player character 4, the first operation type includes two actions including an action for displaying a list of bullet types and an action for selecting a bullet type from the list. On the other hand, the second operation type includes one action in which one bullet type is selected in rotation each time when a predetermined button is pressed.

The notification display control section 230 makes notification performed on the player terminal related to each of the player characters detected by the involved situation detection section 214 to notify that the gameplay control according to the detection is performed. This corresponds to the display control related to the notification display 16 (16a, 16b; see FIG. 5).

When the involved situation gameplay control section 220 performs the gameplay control according to the detection by the involved situation detection section 214, the reinforcement control processing section 232 performs reinforcement control processing to enhance a parameter value of the second player character.

The timer section 280s uses a system clock to measure various times such as a current date and time, or a limited time period.

The sound generation section 290s is implemented by executing an IC or software for generating or decoding sound data, and generates or decodes sound data of operational sounds, sound effects, BGM, voice speech, or the like related to system management of the server system 1100 or provision of an online game. The sound generation section 290s outputs sound signals related to the system management to the sound output section 390s.

The sound output section 390s is implemented by a speaker or the like, and emits sounds based on the sound signals.

The image generation section 292s generates images of various management screens for the system management of the server system 1100, and outputs image data to the image display section 392s. The image display section 392s is implemented by a device for displaying the image such as a flat panel display, a head-mounted display, or a projector.

Furthermore, the image display section 392s renders the game space images of the common game space 8 and the special game space 10 that are bases of the gameplay images displayed on each of the player terminals 1500 (see FIG. 5).

The communication control section 294s performs data processing related to data communication, and implements data exchange with an external device through the communication section 394s.

The communication section 394s connects to the network 9 to implement communication. For example, the communication section 394s is implemented by a transceiver, a modem, a terminal adaptor (TA), a jack for wired communication cable, or a control circuit. The communication section 394s corresponds to the communication device 1153 in an example in FIG. 1.

The server storage section 500s stores programs and various types of data for implementing various functions for causing the server processing section 200s to comprehensively control the server system 1100. The server storage section 500s is used as a work area for the server processing section 200s, and temporarily stores results of calculations executed by the server processing section 200s in accordance with the various types of programs. This function is implemented by an IC memory such as a RAM or a ROM, a magnetic disk such as a hard disk, an optical disk such as a CD-ROM or a DVD, an online storage, or the like. The server storage section 500s corresponds to a storage medium, such as the IC memory 1152 and a hard disk mounted in the main body device 1101 in the example in FIG. 1. The server storage section 500s may include an online storage.

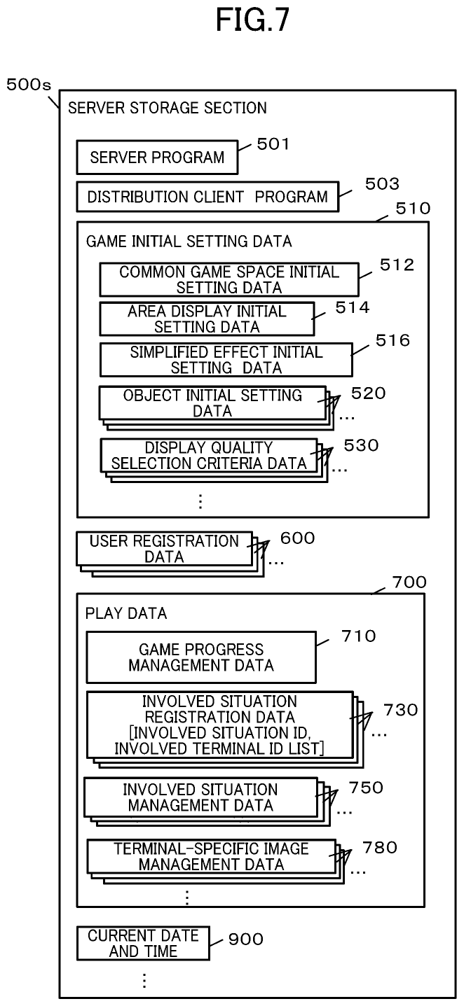

FIG. 7 is a diagram illustrating an example of the programs and data stored in the server storage section 500s. The server storage section 500s according to the present embodiment stores a server program 501, a distribution client program 503, game initial setting data 510, user registration data 600, play data 700, and a current date and time 900. The server storage section 500s also stores other programs and data (e.g., a timer, a counter, or various flags) as appropriate.

The server program 501 is read out and executed by the server processing section 200s so that the server processing section 200s implements functions of the user management section 202 and the game management section 210.

The distribution client program 503 is an original of a program that is provided to the player terminal 1500 to be executed.

The game initial setting data 510 stores various types of initial setting data related to the online game. For example, the game initial setting data 510 includes common game space initial setting data 512, area display initial setting data 514 defining the area display 20 (see FIG. 3), simplified effect initial setting data 516 defining the simplified effect 22 (see FIG. 3), object initial setting data 520, and display quality selection criteria data 530. Other types of data may be included as appropriate, of course.

The common game space initial setting data 512 stores various types of data defining a state of the common game space 8 at a game start. For example, the common game space initial setting data 512 includes definition data of a shape of the common game space 8, a type and a disposed position of a background object, and a type and a disposed position of an NPC 6.

The object initial setting data 520 is prepared for each type of various objects that appear in the game, and stores various types of initial setting data defining the objects.

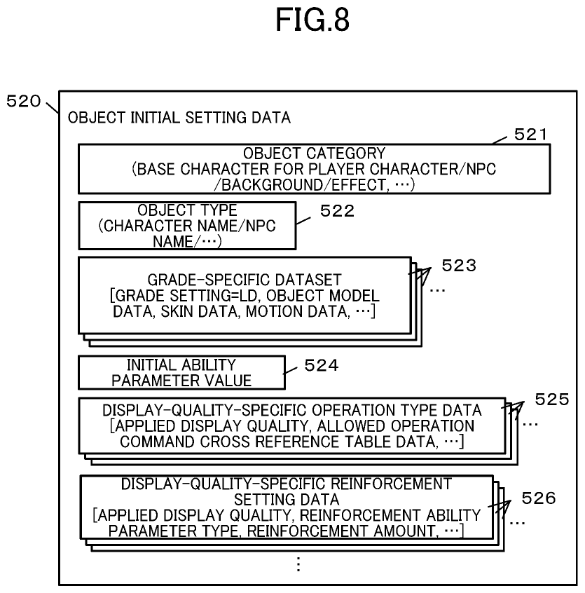

For example, one piece of the object initial setting data 520 includes, as shown in FIG. 8, an object category 521, an object type 522, a grade-specific dataset 523, an initial ability parameter value 524, display-quality-specific operation type data 525, and display-quality-specific reinforcement setting data 526. Other types of data may be included as appropriate depending on game content, of course.

The object category 521 indicates which category the object belongs to, such as a base character for a player character, an NPC, a background, an effect, or equipment.

The grade-specific dataset 523 is prepared for each grade. In the present embodiment, three grade-specific datasets 523 are prepared to correspond to the three grades including the LD, SD, and HD. One grade-specific dataset 523 includes a grade setting indicating a grade to which the dataset is applied, object model data, skin data, and motion data. Other setting data for disposing, controlling, and displaying the objects in the game space may be included as appropriate, of course.

The object model data varies in details depending on the grade. The details become finer in an order of the LD, SD, and HD, and the number of vertexes and the number of polygons included in the object increase accordingly. Types of models such as a polygon model, or a particle model may be made different depending on the grade.

The grade-specific motion data may include a setting of whether physical phenomenon simulation is used or not. For example, a traveling track and a traveling timing of the object may be determined beforehand in the motion data of the LD grade and the SD grade, whereas traveling of the object may be calculated and determined each time by a physical calculation engine in the HD grade.

In addition to the grade-specific datasets 523 of the LD, SD, and HD, a grade-specific dataset 523 dedicated to the common game space 8 may be prepared separately.

The initial ability parameter value 524 stores an initial value when the object is set to exhibit a certain ability during the game progress. For example, when the object is the player character 4, the initial ability parameter value 524 stores initial parameter values of durability, offensive strength, defensive strength, mobility, or resilience. When the object is the equipment that the player character 4 bears such as a weapon or a protection, the initial ability parameter value 524 stores initial parameter values defining effects of the equipment such as a change value of the offensive strength, or a change value of the defensive strength.

The display-quality-specific operation type data 525 is prepared for each grade, and defines the operation type allowed to use on the involved terminal set with the relevant display quality. In particular, one piece of the display-quality-specific operation type data 525 includes applied display quality corresponding to an application requirement of the relevant data, and allowed operation command cross reference table data.

In the display-quality-specific operation type data 525, a number of allowed types of operation commands (operation type) is set to increase as the applied display quality rises. Alternatively, content of the operation commands itself may be made different. For example, when the applied display quality is low, the operation commands mainly include operation commands that are relatively simple to operate and are estimated to have low input frequency, such as a defense role, a rear-guard role, or a supporter role. On the contrary, when the applied display quality is high, the operation commands mainly include operation commands that are relatively complicated to operate and are estimated to have high input frequency, such as an offense role, an advanced guard role, or a player role. In this manner, in a configuration where the roles in the play related to the involved situation are practically divided by the content of the operation commands, names of the roles are preferably displayed in the notification display 16 (see FIG. 5).

The display-quality-specific reinforcement setting data 526 is prepared for each grade of the display quality, and defines reinforcement to be applied to the player character 4 of the involved terminal set with the relevant display quality. In particular, one piece of the display-quality-specific reinforcement setting data 526 includes applied display quality corresponding to an application requirement of the relevant data, a reinforcement ability parameter value indicating a parameter of a reinforcement target, and a reinforcement amount of the parameter value (any of positive, negative, and zero amounts can be set).

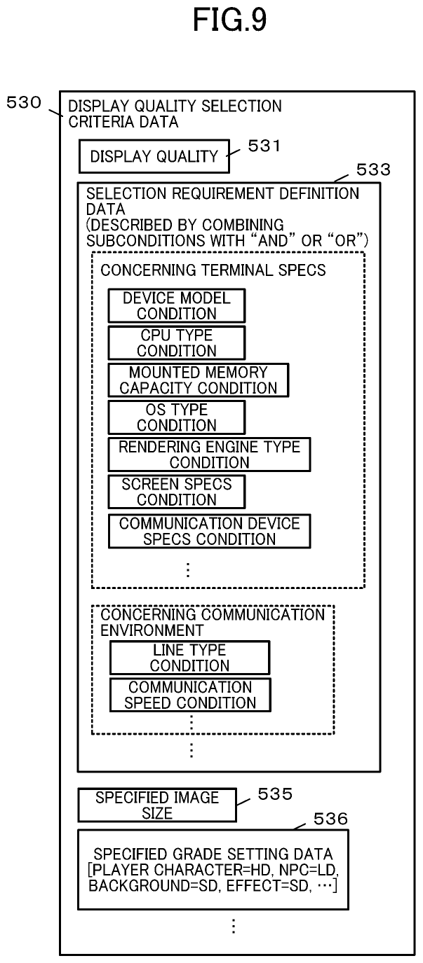

Referring back to FIG. 7, the display quality selection criteria data 530 stores various types of data related to the selection of the display quality to be applied when the player terminal 1500 becomes the involved terminal based on the gameplay specs of the player terminal 1500. In particular, as shown in FIG. 9 for example, one piece of the display quality selection criteria data 530 includes unique display quality 531, selection requirement definition data 533, specified image size 535, and specified grade setting data 536.

The selection requirement definition data 533 is the data that defines a condition of the gameplay specs which should be satisfied to select the display quality, and is described by one sub-condition or a combination of a plurality of sub-conditions using AND or OR. For example, the sub-conditions can include, in relation to the specs of the player terminal 1500, a device model condition, a CPU type condition, a mounted memory capacity condition, an OS type condition, a rendering engine type condition, a screen specs condition, or a communication device specs condition. That is, conditions related to the specs affecting the calculation processing ability or the communication processing ability can be used. Furthermore, for example, the sub-condition related to the communication environment can include a line type condition, or a communication speed condition.

The specified image size 535 specifies an image size of the gameplay image 14 for the involved terminal when the relevant display quality is selected, in association with the selection requirement of the display quality (see FIGS. 4 and 5).

The specified grade setting data 536 specifies a grade setting for each of the categories of the objects disposed in the special game space 10 for the involved terminal when the relevant display quality is selected, in association with the selection requirement of the display quality (see FIG. 4).

Referring back to FIG. 7, the user registration data 600 is prepared for each registered user who is to be a player, and stores various types of data associated with the user.

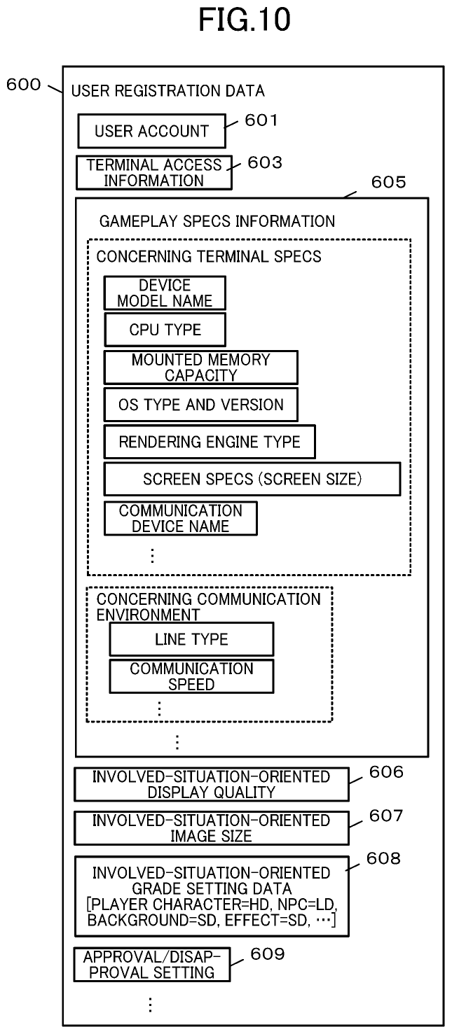

One piece of the user registration data 600 includes, as shown in FIG. 10 for example, a unique user account 601, terminal access information 603, gameplay specs information 605, involved-situation-oriented display quality 606, an involved-situation-oriented image size 607, involved-situation-oriented grade setting data 608, and an approval/disapproval setting 609. The terminal access information 603 is the information for accessing the player terminal 1500 via the network 9, and includes an IP address, for example. Other types of data, such as saved data of the online game, may be included as appropriate, of course.

Information included in the gameplay specs information 605 corresponds to items of the sub-conditions describing the selection requirement definition data 533 (see FIG. 9) of the display quality selection criteria data 530.

The involved-situation-oriented display quality 606 indicates the type of the display quality to be applied when the player character 4 of the user enters the involved situation and the special game space 10 is set. Basically, the involved-situation-oriented display quality 606 is set with the display quality 531 of the display quality selection criteria data 530, the selection requirement definition data 533 (see FIG. 9) of which is satisfied. However, as will be described later, when the setting is customized by the player after the setting of the involved-situation-oriented display quality 606 is presented to the player, the involved-situation-oriented display quality 606 is set with a predetermined value indicating a predetermined “customized setting”.

The involved-situation-oriented image size 607 is set with the specified image size 535 of the display quality selection criteria data 530, the selection requirement definition data 533 (see FIG. 9) of which is satisfied.

The involved-situation-oriented grade setting data 608 is initially set with the specified grade setting data 536 of the display quality selection criteria data 530, the selection requirement definition data 533 (see FIG. 9) of which is satisfied. However, as will be described later, when the setting is customized by the player after the setting of the involved-situation-oriented grade setting data 608 is presented to the player, the involved-situation-oriented grade setting data 608 is changed to a customized result.

The approval/disapproval setting 609 stores a selection result of the user's approval/disapproval of performing the control with the display quality according to the gameplay specs in the involved situation. In other words, the approval/disapproval setting 609 indicates the setting of the approval/disapproval related to switching to the second gameplay control by the involved situation gameplay control section 220 as the individual setting of each of the player terminals 1500. An initial value of this setting is a value indicating the approval. When the user selects the disapproval (denial) at approval/disapproval selection acceptance before the game starts, the initial value is changed.

Referring back to FIG. 7, the play data 700 stores various types of data related to the implementation of the online game, and is successively updated according to the game progress. The play data 700 includes game progress management data 710, involved situation registration data 730, involved situation management data 750, and terminal-specific image management data 780. Other types of data may be stored as appropriate, of course.

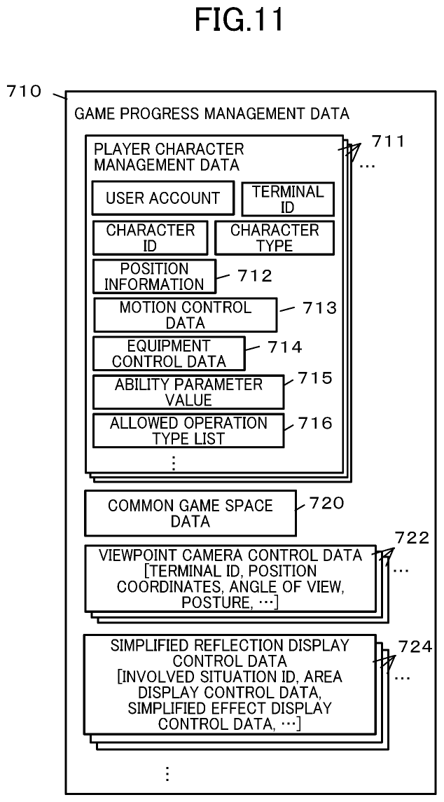

The game progress management data 710 stores various types of data describing game progress status of the online game. In particular, as shown in FIG. 11, the game progress management data 710 includes player character management data 711, common game space data 720, viewpoint camera control data 722, and simplified reflection display control data 724. Other types of data may be stored as appropriate, of course.

The player character management data 711 is prepared for each player character, and stores various types of data related to the player character. One piece of the player character management data 711 includes, as information associating the player with the player character, a user account indicating the player who uses the character, a unique terminal ID indicating the player terminal 1500 of the player, a unique character ID, a character type indicating a base of the character. The player character management data 711 also includes, as information indicating a latest state of the player character 4, position information 712 of a representative point of the character in the common game space 8, motion control data 713, equipment control data 714, an ability parameter value 715, and an allowed operation type list 716. Other types of data may be stored as appropriate, of course.

Although not shown, similar management data related to the NPC 6 is also included in the game progress management data 710.

The common game space data 720 is a data group including vertex data and polygon data of the object models of the various types of objects disposed in the common game space 8 in a latest state.

The viewpoint camera control data 722 is prepared for each player terminal 1500, and stores various types of data indicating a state of a viewpoint camera of the gameplay image 14 displayed on the player terminal. In particular, one piece of the viewpoint camera control data 722 stores a terminal ID (or a user account), and information such as position coordinates, an angle of view, posture, or the like in the common game space 8.

The simplified reflection display control data 724 is prepared for each involved situation, and stores various types of data for reflecting and displaying, in a simplified manner, a state in the special game space 10 related to the involved situation to the common game space 8. One piece of the simplified reflection display control data 724 includes area display control data and simplified effect display control data. Other types of data such as data of the objects related to the simplified reflection display may be included.

Referring back to FIG. 7, the involved situation registration data 730 is generated each time when the involved situation detection section 214 detects that the player characters 4 in the common game space 8 have entered the involved situation. One piece of the involved situation registration data 730 includes a unique involved situation ID and an involved terminal ID list. The involved terminal ID list is a terminal ID list of the player terminals 1500 associated with the player characters 4 that have entered the involved situation. Other types of data may be stored as appropriate, of course. For example, when a time limit is set to the involved situation, a start date and time of the involvement may be stored.

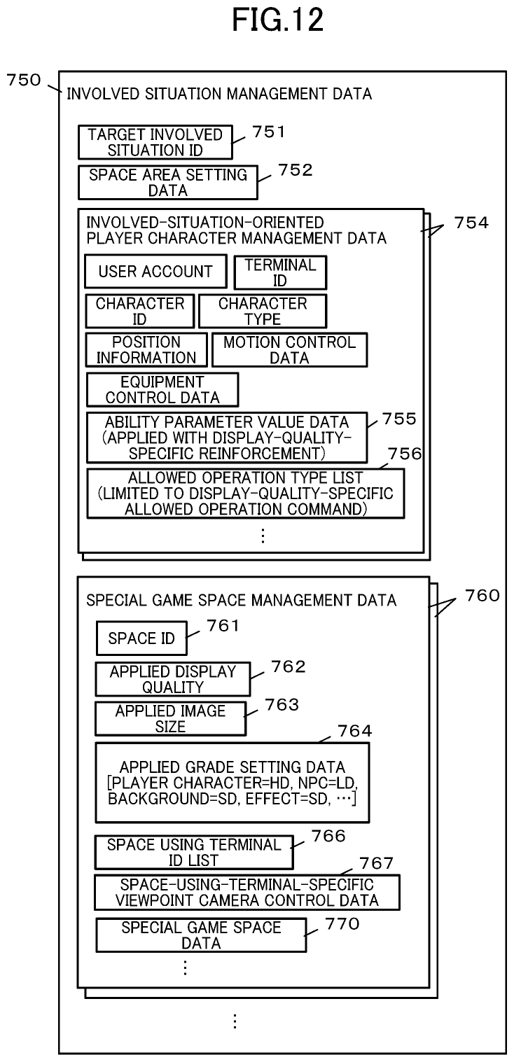

The involved situation management data 750 is generated each time when the involved situation is detected, and stores various types of data describing latest progress control of the play in the special game space 10 of the involved situation. In particular, as shown in FIG. 12, one piece of the involved situation management data 750 includes a target involved situation ID 751 indicating a corresponding involved situation, space area setting data 752, involved-situation-oriented player character management data 754 of each of the player characters 4 in the involved situation, and special game space management data 760. Other types of data may be stored as appropriate, of course. For example, the involved situation management data 750 can also include a timer value for measuring the time limit required for determination of the end condition of the involved situation.

The space area setting data 752 indicates which part of the common game space 8 corresponds to the special game space 10 related to the involved situation. For example, the space area setting data 752 stores position coordinates of a boundary of the special game space in the common game space 8, or position coordinate values of a representative point of the special game space in the common game space 8 when the special game space 10 is set to a specific size.

As for the involved-situation-oriented player character management data 754, the player character management data 711 (see FIG. 11) of the relevant character at the occurrence of the involved situation is copied.

However, the ability parameter value data 755 and the allowed operation type list 756 are changed according to the display quality set to the involved terminal after copying. In particular, the object initial setting data 520 (see FIG. 8) of the player character 4 is referred to, and the ability parameter value data 755 is changed according to the setting of the display-quality-specific reinforcement setting data 526 matching the display quality indicated by the involved-situation-oriented display quality 606 (see FIG. 10) of the involved terminal corresponding to the relevant player character 4. The allowed operation type list 756 is changed according to the setting of the display-quality-specific operation type data 525 matching the display quality indicated by the involved-situation-oriented display quality 606 of the involved terminal.

When the NPC 6 is disposed in the special game space 10 in the involved situation, data similar to the involved-situation-oriented player character management data 754 is prepared for each NPC 6.

The special game space management data 760 is prepared for each special game space 10 generated due to the involved situation, and stores various types of data related to the settings and management of the game space. Since FIG. 12 shows an example including two involved terminals having different types of involved-situation-oriented display quality 606, two pieces of the special game space management data 760 are illustrated. However, a number of pieces of the special game space management data 760 may be one, three, or more depending on circumstances.

One piece of the special game space management data 760 includes a unique space ID 761, an applied display quality 762, an applied image size 763, applied grade setting data 764, a space using terminal ID list 766, space-using-terminal-specific viewpoint camera control data 767, and special game space data 770. Other types of data can be included as appropriate, of course.

The applied display quality 762 indicates the display quality to be applied to the relevant special game space. In particular, any of the types of the display quality 531 of the display quality selection criteria data 530 (see FIG. 9) is set.

The applied image size 763 indicates an image size to be applied when the game space image 12 is rendered based on the special game space 10. Basically, the specified image size 535 of the display quality selection criteria data 530 (see FIG. 9) corresponding to the applied display quality 762 is copied. However, when the setting is customized by the player, content of the relevant setting data is changed from the copied content as appropriate.

The applied grade setting data 764 indicates a grade to be applied to each of the categories of the objects disposed in the special game space. Basically, the applied grade setting data 764 is a copy of the specified grade setting data 536 of the display quality selection criteria data 530 (see FIG. 9) corresponding to the applied display quality 762. However, when the setting is customized by the player, content of the relevant setting data is changed from the copied content as appropriate.

The space using terminal ID list 766 stores the terminal IDs of the involved terminals that use the relevant special game space 10 to generate the gameplay image 14, that is, the terminal IDs of space using terminals.

The space-using-terminal-specific viewpoint camera control data 767 is prepared for each space using terminal, and stores information related to control of a viewpoint camera for rendering the game space image 12 which is a base of the gameplay image 14 displayed on the relevant terminal. For example, the space-using-terminal-specific viewpoint camera control data 767 includes a terminal ID, and position coordinates, an angle of view, or posture in the special game space 10.

The special game space data 770 is a data group including vertex data and polygon data of the object models disposed in the special game space. The grades of the object models to be used are the grades according to the applied display quality 762. Accordingly, when the special game space management data 760 varies, the number of polygons or the like included in the special game space data 770 varies by an amount corresponding to a difference in the grades of the object models.

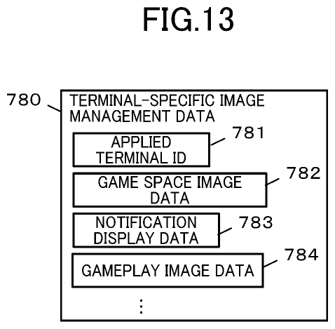

Referring back to FIG. 7, the terminal-specific image management data 780 is prepared for each player terminal 1500, and stores various types of information for displaying the gameplay image 14 on the relevant terminal. One piece of the terminal-specific image management data 780 includes, as shown in FIG. 13 for example, an applied terminal ID 781 indicating an application target of the management data, game space image data 782 of the game space image 12, notification display data 783 of the notification display 16, and gameplay image data 784 of the gameplay image 14 (see FIG. 5). Other types of data may be stored as appropriate, of course.

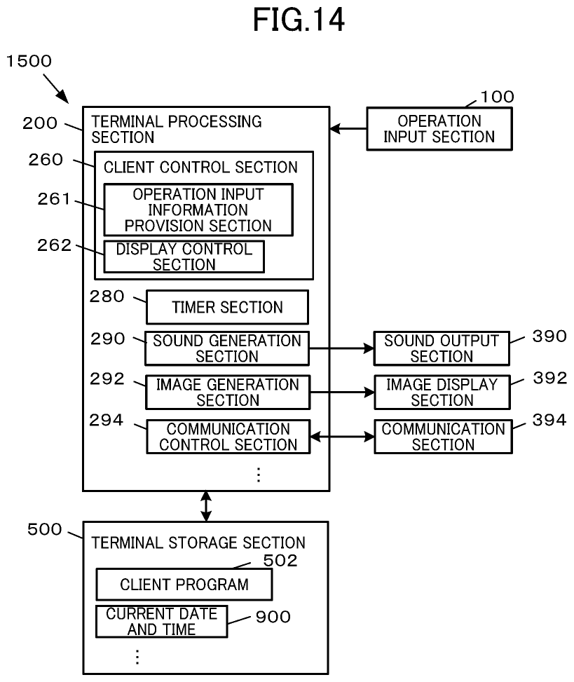

FIG. 14 is a functional block diagram illustrating a functional configuration example of the player terminal 1500. The player terminal 1500 includes an operation input section 100, a terminal processing section 200, a sound output section 390, an image display section 392, a communication section 394, and a terminal storage section 500.

The operation input section 100 outputs operation input signals according to various types of operation input made by the player to the terminal processing section 200. The operation input section 100 can be implemented, for example, by a push switch, a joystick, a touch pad, a track ball, an accelerometer, or a gyro.

The terminal processing section 200 is implemented, for example, by a microprocessor such as a CPU or a GPU, and electronic components such as an IC memory. The terminal processing section 200 performs input/output control of data to/from the functional sections including the operation input section 100 and the terminal storage section 500. The terminal processing section 200 also performs various calculation processing based on predetermined programs and data, operation input signals from the operation input section 100, and various types of data received from the server system 1100 to control the operation of the player terminal 1500.

The terminal processing section 200 according to the present embodiment includes a client control section 260, a timer section 280, a sound generation section 290, an image generation section 292, and a communication control section 294.

The client control section 260 performs control as a game client in a game system of a client-server type (C/S type). In particular, the client control section 260 includes an operation input information provision section 261, and a display control section 262.

The operation input information provision section 261 performs control for sending operation input information to the server system 1100 according to the input from the operation input section 100.

The display control section 262 performs control for displaying the gameplay image 14 based on data received from the server system 1100. However, in the present embodiment, since the gameplay image 14 is generated by the server system 1100, the display control section 262 does not perform control related to rendering of the game space image 12. When compressed data is provided from the server system 1100 as the data for displaying the gameplay image 14, the display control section 262 performs decompression processing of this data or the like.

The timer section 280 uses a system clock to measure a current date and time, a limited time period, or the like.

The sound generation section 290 is implemented, for example, by a processor such as a digital signal processor (DSP) or a sound synthesizing IC, or an audio codec for playing a sound file. The sound generation section 290 generates sound signals for music, sound effects, or various types of operational sounds and outputs the signals to the sound output section 390.

The sound output section 390 is implemented by a device that outputs (emits) sounds based on the sound signals input from the sound generation section 290, such as a speaker.

The image generation section 292 generates images based on the control by the client control section 260, and outputs image signals to the image display section 392. The image generation section 292 corresponds to the graphics processing unit (GPU) and a graphic controller mounted on the control board 1550 in the example in FIG. 1.

The image display section 392 is implemented by a device for displaying images such as a flat panel display, a head-mounted display, or a projector.

The communication control section 294 performs data processing related to data communication, and implements data exchange with an external device through the communication section 394.

The communication section 394 connects to the network 9 to implement communication. For example, the communication section 394 is implemented by a transceiver, a modem, a terminal adaptor (TA), a jack for wired communication cable, or a control circuit. The communication section 394 corresponds to the communication module 1553 in the example in FIG. 1.

The terminal storage section 500 stores programs and various types of data for causing the terminal processing section 200 to implement given functions. The terminal storage section 500 is also used as a work area for the terminal processing section 200, and temporarily stores results of calculations executed by the terminal processing section 200 in accordance with various programs, input data input from the operation input section 100, or the like. These functions are implemented, for example, by an IC memory such as a RAM or a ROM, a magnetic disk such as a hard disk, or an optical disk such as a CD-ROM or a DVD. The terminal storage section 500 corresponds to the IC memory 1552 mounted on the control board 1550 in the example in FIG. 1. In particular, the terminal storage section 500 stores a client program 502 (an application program) for causing the terminal processing section 200 to function as the client control section 260, and a current date and time 900. Other types of data may be stored as appropriate, of course. For example, the terminal storage section 500 may store the game initial setting data 510 (see FIG. 7) downloaded from the server system 1100 as appropriate.

Next, operation of the game system 1000 is described.

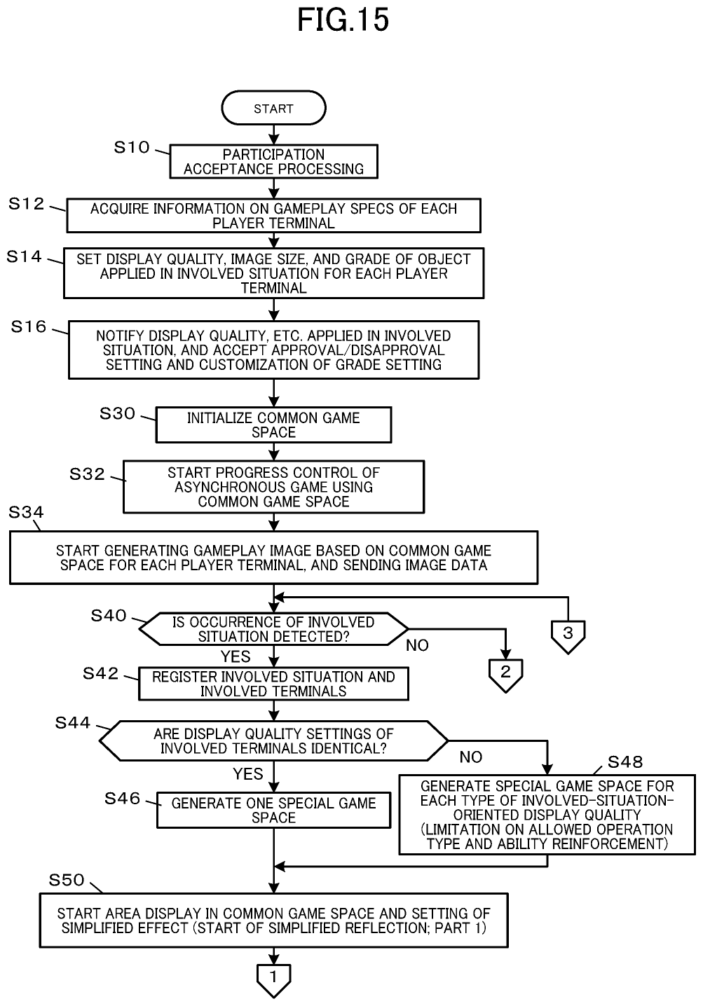

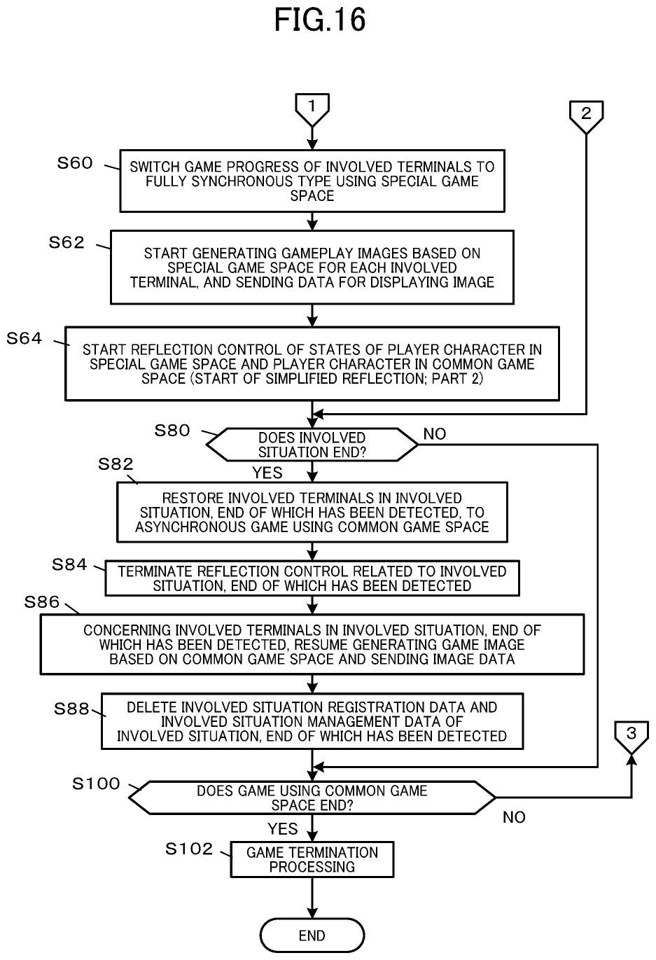

FIGS. 15 and 16 are a flowchart illustrating a flow of processing related to online game execution performed by the server system 1100.

As shown in FIG. 15, the server system 1100 performs processing for accepting participation in an online game (step S10). The server system 1100 acquires information (e.g., a device model, a CPU type, or a line type) related to the gameplay specs of each of the player terminals 1500 that have applied for the participation, and stores the information as the gameplay specs information 605 (see FIG. 10) of the user registration data 600 (step S12).

Next, the server system 1100 selects the display quality to be applied to each of the player terminals 1500 (step S14). In particular, the server system 1100 checks the gameplay specs information 605 against the display quality selection criteria data 530 (see FIG. 9), and initializes the involved-situation-oriented display quality 606, the involved-situation-oriented image size 607, and the involved-situation-oriented grade setting data 608 (see FIG. 10).

Then, the server system 1100 displays initialized results of these settings on each of the player terminals 1500 so as to notify the results to the players and accept customization (step S16). In this customization procedure, firstly, the server system 1100 accepts arbitrary selection of the approval/disapproval of executing the control with the display quality according to the gameplay specs in the involved situation from each of the players. The server system 1100 sets an approval/disapproval result to the approval/disapproval setting 609 (see FIG. 10).

Secondly, in the customization procedure, the server system 1100 complies with the preferences of the player for appearance of the gameplay image. For example, even if all grade settings are initialized to the “SD” in the involved-situation-oriented grade setting data 608, the grade of the object such as the NPC 6 or the background may be changed to the “LD”, and the grade of the player character 4 may be changed to the “HD”, if the player desires. In this case, it is possible to customize the gameplay image 14 to comply with the preferences of the player such that the appearance of the player character 4 is secured even if the appearance of the NPC 6 or the background is degraded. When the approval/disapproval setting 609 is set to a setting corresponding to the “disapproval”, the setting in the involved-situation-oriented grade setting data 608 is not applied to the involved-situation play, and thus the appearances in the common game space 8 and the gameplay image 14 do not basically differ.

Next, the server system 1100 initializes the common game space 8 (step S30).

The server system 1100 initially arranges the player characters 4, the NPC 6, the background objects, or the like in the common game space 8. These objects in respective categories are set with predetermined grades for the common game space 8 (e.g., the SD grade, or a dedicated grade).

Next, the server system 1100 starts the game progress control of the game as the asynchronous MMO game using the common game space 8 (step S32), and starts generating and sending the data for displaying the gameplay image 14 on each of the player terminals 1500 (step S34).

That is, the server system 1100 controls the motion of the player character 4 associated with the terminal based on the operation input information received from the player terminal 1500, and automatically controls the NPC 6. In addition, the server system 1100 controls the viewpoint camera for each of the player terminal 1500 accordingly. Then, the server system 1100 renders an image (game space image 12) of the common game space 8 seen from the viewpoint camera, combines various types of information display to generate the gameplay image 14, and sends the data for displaying the gameplay image 14 to each of the player terminals 1500.

An image size, a number of colors of the image, or the like of the gameplay image 14 for the common game space 8 are assumed to be appropriately set to ensure a “pleasant play experience” using the image having the highest possible quality as the asynchronous MMO game. As for these settings, predetermined values separately prepared beforehand according to the gameplay specs may be selectively used as appropriate according to the gameplay specs of each of the player terminals 1500.

Once the server system 1100 starts the game progress control, the server system 1100 constantly monitors the occurrence of the involved situation. When the server system 1100 detects the occurrence of the involved situation (YES at a step S40), the server system 1100 generates the involved situation registration data 730 (see FIG. 7) and resisters the player terminals 1500 of the player characters 4 that have entered the involved situation as the “involved terminals” (step S42).

Next, the server system 1100 refers to the involved-situation-oriented display quality 606 (see FIG. 10) of the involved terminals, and determines whether the settings of the display quality of the involved terminals are identical (step S44).

When the player using the involved terminal with the inferior gameplay specs sets the approval/disapproval setting 609 (see FIG. 10) to the “disapproval”, the setting of the relevant involved terminal is considered to be the same as the setting of the involved-situation-oriented display quality 606 of the involved terminal with the superior gameplay specs, regardless of the setting of the involved-situation-oriented display quality 606 of the relevant involved terminal. Alternatively, the setting is considered to be a predetermined quality corresponding to the display quality of the gameplay image 14 in the common game space 8.

Then, when the settings of the involved-situation-oriented display quality 606 of all the involved terminals are identical (YES at the step S44), the server system 1100 generates one new piece of the involved situation management data 750, and generates one piece of the special game space data 770 (step S46).

In particular, the server system 1100 copies the player character management data 711 (see FIG. 11) of the plurality of player characters 4 that have entered the involved situation to the involved-situation-oriented player character management data 754 of this new involved situation management data 750 (see FIG. 12). Then, as described above, the server system 1100 changes the ability parameter value data 755 and the allowed operation type list 756 according to the involved-situation-oriented display quality 606 (see FIG. 10) set to the involved terminal of each of the player characters 4.

In particular, with regard to the ability parameter value data 755, the server system 1100 changes a parameter value according to the display-quality-specific reinforcement setting data 526 of the object initial setting data 520 (see FIG. 8) after copying. That is, the reinforcement according to the applied display quality 762 is performed. When the reinforcement is performed only for one of the player terminals 1500 having the different gameplay specs, a handicap effect is produced in performing the involved-situation play. When the reinforcement is performed, the server system 1100 may perform notification display to show that the reinforcement is performed on the player terminal 1500 of the player character 4 applied with the reinforcement.

The allowed operation type list 756 is limited to the allowed operation command indicated by the display-quality-specific operation type data 525 of the object initial setting data 520 after copying. Similar to the reinforcement case described above, when this limitation is performed only for one of the player terminals 1500 having the different gameplay specs, a handicap effect is produced in performing the involved-situation play.

Of course, it is possible to adopt a configuration where only one of the reinforcement of the ability parameter value and the change of the operation type is performed.

The server system 1100 generates one piece of the special game space management data 760 in this new involved situation management data 750. The server system 1100 copies the involved-situation-oriented display quality 606, which has been determined to be identical, to the applied display quality 762 (see FIG. 12), and copies the involved-situation-oriented grade setting data 608 of the involved terminals to the applied grade setting data 764. The display grade of the objects disposed in the special game space 10 of the special game space data 770 is the grade indicated by the applied grade setting data 764.

The server system 1100 registers the involved terminal, out of the plurality of involved terminals, whose involved-situation-oriented display quality 606 matches the applied display quality 762 to the space using terminal ID list 766.

The server system 1100 initializes the space-using-terminal-specific viewpoint camera control data 767 so as to take over orientation or a position of the player character 4 corresponding to the space using terminal in the common game space 8 at the time when the player character 4 enters the involved situation. This initialization reduces unnatural feeling due to a sudden change in a viewpoint position caused when the gameplay image 14 of the gameplay using the common game space 8 on the involved terminal shifts to the gameplay image 14 of the gameplay using the special game space 10.

On the other hand, when the settings of the involved-situation-oriented display quality 606 of all the involved terminals are not identical (No at the step S44), the server system 1100 generates a new piece of the involved situation management data 750, and generates the special game space management data 760 for each of the types of the involved-situation-oriented display quality 606 of the involved terminals (step S48). In the example in FIG. 3, the server system 1100 generates the special game space management data 760 for each of the special game space 10a and the special game space 10b. A generation procedure of the special game space management data 760 is the same as that in the step S46.

The server system 1100 sets the terminal IDs of the involved terminals whose settings of the involved-situation-oriented display quality 606 are the same to the space using terminal ID list 766 (see FIG. 12), and generates the space-using-terminal-specific viewpoint camera control data 767 respectively.

That is, in the step S48, upon detection of the involved situation, there have been performed the first terminal image control for making the gameplay image on the first player terminal (first involved terminal having the superior gameplay specs) have the first display quality (involved-situation-oriented display quality 606), and the second terminal image control for making the gameplay image on the second player terminal (second involved terminal with the inferior gameplay specs) have the second display quality that is inferior to the first display quality.

In particular, by selecting and disposing the object models of the grade specified by the involved-situation-oriented display quality 606 in the corresponding special game space 10, there have been performed the control for making the class of the objects displayed in the gameplay image on the first player terminal the first class, and the control for making the class of the objects displayed in the gameplay image on the second player terminal the second class that is inferior to the first class in quality.

In the step S48, there have been performed the first terminal operation type control for making the allowed types of the operation input on the first player terminal the first operation type, and second terminal operation type control for making the allowed types of the operation input on the second player terminal the second operation type that includes a fewer number of types of the operation input than the first operation type.

In the step S48, when the gameplay control according to the detection of the involved situation is performed, the reinforcement control processing for enhancing the parameter value of the player character of the second player terminal has been performed.

As described above, in the step S44, with regard to the involved terminal (second player terminal) that has the inferior gameplay specs and whose approval/disapproval setting 609 (see FIG. 10) is set to the “disapproval”, the setting is considered to be the same as the setting of the involved-situation-oriented display quality 606 of another involved terminal (first player terminal) having the superior gameplay specs, regardless of the setting of the involved-situation-oriented display quality 606 of the relevant involved terminal. Alternatively, the setting is considered to be the predetermined quality corresponding to the display quality of the gameplay image 14 in the common game space 8. Accordingly, when the process reaches the step S48 as a result, the first gameplay control related to the display quality to be performed to the involved terminal having the superior gameplay specs is also performed to the involved terminal having the inferior gameplay specs.

As for the steps S44 to S48, when the involved situation is read as an event, it can be rephrased that the server system 1100 has detected the occurrence of the event in the common game space 8, and generated at least one special game space for implementing the display quality appropriate for the gameplay specs of each of the involved player terminals 1500 based on a number of player terminals 1500 involved in the event and the gameplay specs of these player terminals 1500.

After the server system 1100 generates the special game space 10 in the step S46 or S48, the server system 1100 disposes the object of the area display 20 of the newly generated special game space 10 in the common game space 8 (step S50). Accordingly, the player characters 4 of the player terminals 1500, other than the involved terminals, existing outside the special game space 10, can see the special game space.

Referring to FIG. 16, the server system 1100 switches the game progress of the player characters 4 that have newly entered the involved situation to the fully synchronous game using the special game space 10, and starts the involved-situation play (step S60).

The server system 1100 starts control for rendering the game space image 12 based on the special game space 10 on each of the involved terminals, generating the gameplay image 14, and sending the data for displaying the generated gameplay image (step S62). The image size of the gameplay image 14 for each of the involved terminals is the specified image size 535 (see FIG. 9) of the display quality indicated by the applied display quality 762. The data for displaying the gameplay image 14 may be image data of the gameplay image 14, or compressed data of the image data.

When the plurality of special game spaces 10 are generated in the step S48, and the involved situation is detected, performing the steps S60 to S62 results in performing the first gameplay control set according to the gameplay specs of the first player terminal (first involved terminal) to the relevant terminal. In addition, it also results in performing the second gameplay control set according to the gameplay specs of the second player terminal (second involved terminal) to the relevant terminal.

The operation input information from each of the involved terminals after the step S60 is used for the game progress control using the special game space 10, but not directly for the game progress control using the common game space 8. Instead, the server system 1100 starts the reflection control for reflecting the progress control result related to the new special game space 10 to the common game space 8 (step S64).

In particular, the server system 1100 refers to the game progress result (e.g., object control of the player character 4, or a latest ability parameter value) of the player character 4 of each of the involved terminals in the special game space 10. Then, the server system 1100 changes the position information 712, the motion control data 713, the equipment control data 714, and the ability parameter value 715 of the object of the player character 4 of each of the involved terminals in the common game space 8 (see FIG. 11). That is, the server system 1100 causes the player character 4 of each of the involved terminals in the common game space 8 to perform shadowing of the player character 4 of each of the involved terminals in the special game space 10. In addition, in a situation where the effect display such as flashes or explosive smoke is performed in the special game space 10, the effect display is partially or entirely performed by the simplified effect 22 (see FIG. 3) in the common game space 8.

After starting the game progress control using the common game space 8, the server system 1100 constantly monitors an end of each of the involved situations that have occurred. The end condition of the involved situation can be set as appropriate according to the game content. Since the online game according to the present embodiment is the battle royale fighting action game, the involved situation ends when victory or defeat of the battle between the player characters 4 in the involved situation is decided (e.g., one of the player characters 4 is defeated). The involved situation may end when the time limit has passed, of course. In addition, in a case of a turn-based battle, the involved situation may end when a number of turns reaches a setting value.

When the server system 1100 detects the end of the involved situation (YES at a step S80), the server system 1100 restores the game progress of each of the involved terminals in the involved situation the end of which has been detected from the fully synchronous game using the special game space 10 to the asynchronous game using the common game space 8 (step S82). In other words, when the involved situation satisfies the end condition after the detection of the involved situation, the server system 1100 restores the gameplay control performed to each of the involved terminals to the gameplay control before the detection.

Next, the server system 1100 terminates the simplified reflection control of the involved situation the end of which has been detected (step S84). Accordingly, the area display 20 and the object of the simplified effect 22 disposed in the common game space 8 in relation to the involved situation the end of which has been detected are also deleted.

The server system 1100 restores the generation of the gameplay image 14 for the involved terminals in the involved situation the end of which has been detected from the generation based on the special game space 10 to the generation based on the common game space 8 (step S86). The server system 1100 also restores the image size of the gameplay image 14 generated for the involved terminals from the specified image size 535 (see FIG. 9) of the display quality indicated by the applied display quality 762 to the image size for the common game space 8.

Then, the server system 1100 deletes the involved situation registration data 730 and the involved situation management data 750 of the involved situation the end of which has been detected (step S88; see FIG. 7).

The server system 1100 constantly monitors whether an end condition of the asynchronous game using the common game space 8 is satisfied. The server system 1100 repeats the steps S40 to S90 until the end condition is satisfied (NO at a step S100). When the server system 1100 detects that the end condition is satisfied (YES at the step S100), the server system 1100 performs predetermined game termination processing (e.g., declaring the end of the game, announcing ranking, awarding rewards, updating rankings, or saving saved data) (step S102), and terminates a series of processing.

As described above, according to the present embodiment, a new technique can be provided for providing the game client with a pleasant play experience according to the gameplay specs of the game client.

Although various player terminals 1500 having different gameplay specs can participate in the MMO game, it is desired to provide the play experience as pleasant as possible on each of the player terminals 1500. The MMO game using one common game space 8 as a stage is basically carried out as the asynchronous game. When the server system 1100 is configured to generate and provide the gameplay image 14 for the player terminals 1500, the image size of the gameplay image 14, and the number of polygons, the number of colors, fineness of motion of the object model such as the player character 4 are determined to provide the pleasant play experience even on the player terminal 1500 having relatively low gameplay specs.

In particular, the special game space 10 according to the gameplay specs is generated for each of the player terminals 1500 (involved terminals) of the player characters 4 that have entered the involved situation. Then, the gameplay control using the special game space is performed for each of the player terminals 1500 having the different gameplay specs. As a result, the image size of the gameplay image 14, and the number of polygons, the number of colors, the fineness and smoothness of the motion of the object model such as the player character 4 for each of the involved terminals can be optimized according to the gameplay specs of each of the involved terminals.

Therefore, the pleasant play experience can be provided even for the player terminal 1500 having the low gameplay specs in the involved situation. Furthermore, the pleasant play experience with high quality fully utilizing the specs can be provided for the player terminal 1500 having the high gameplay specs.

### Second Embodiment

Next, a second embodiment is described. In the description of the second embodiment, differences from the first embodiment are mainly described. Components that are the same as those in the first embodiment are denoted by the same referential numerals, and duplicate description is omitted.

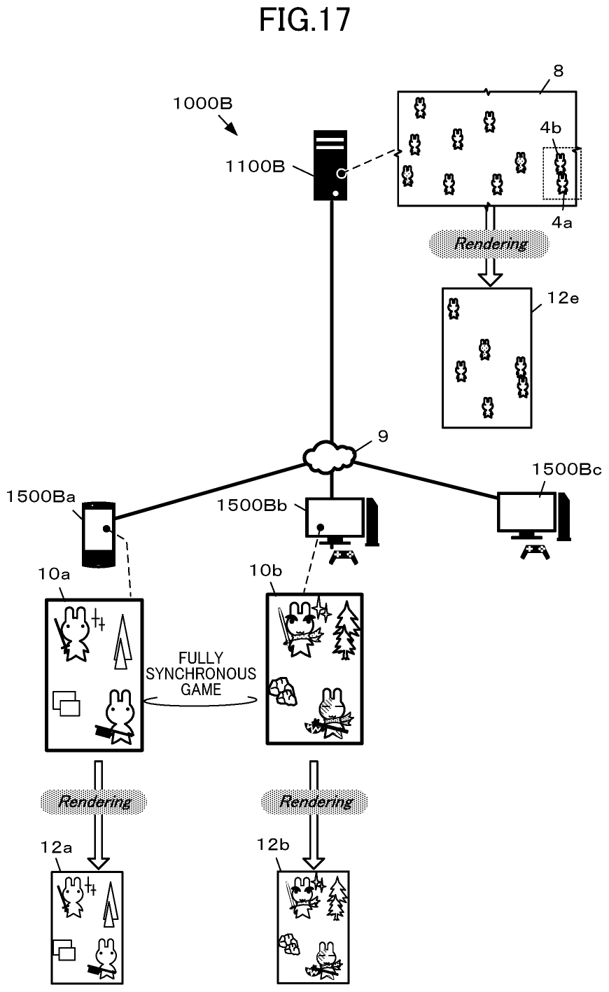

FIG. 17 is a diagram illustrating a system configuration and responsible parties for generation of the game space image 12 and the gameplay image 14 according to the second embodiment.

The configuration of a game system 1000B according to the present embodiment is basically the same as that in the first embodiment. A server system 1100B according to the present embodiment manages data of the common game space 8 to perform progress control of the asynchronous game using the common game space 8. Then, the server system 1100B renders a game space image 12e based on the common game space 8 for each of player terminals 1500B, generates the gameplay image including the game space image 12e, and sends the data for generating the gameplay image to each of the player terminals 1500B.

Although the server system 1100B detects the occurrence of the involved situation and also performs the progress control of the involved-situation play, the server system 1100B does not generate the game space image 12 (12a, 12b) or the gameplay image 14 related to the involved-situation play. Generating the game space image 12 (12a, 12b) and the gameplay image 14 related to the involved-situation play is performed by the player terminal 1500B that has become the involved terminal according to the present embodiment.

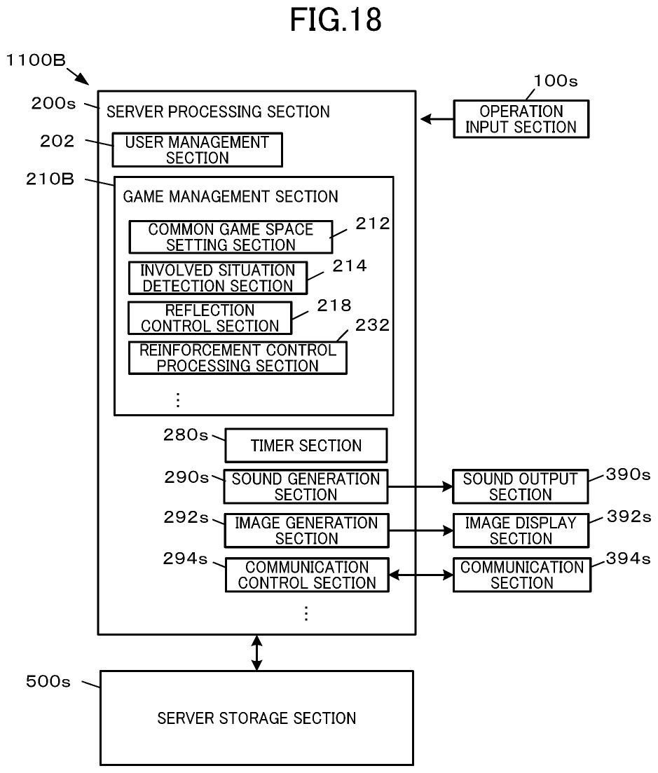

FIG. 18 is a functional block diagram illustrating a functional configuration example of the server system 1100B.

Compared with the functional configuration (FIG. 6 and FIG. 14) according to the first embodiment, the server system 1100B includes a game management section 210B that includes a common game space setting section 212, an involved situation detection section 214, a reflection control section 218, and a reinforcement control processing section 232.

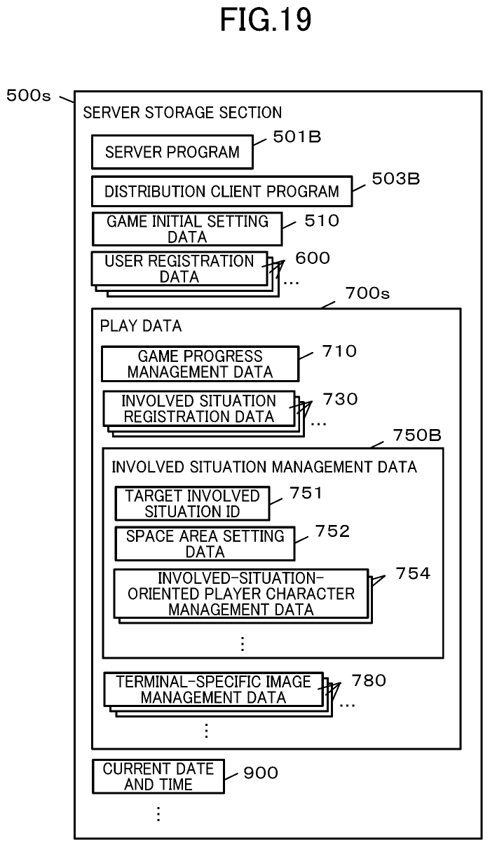

As shown in FIG. 19, a server storage section 500s of the server system 1100B stores a server program 501B, a distribution client program 503B, game initial setting data 510, user registration data 600, and play data 700s.

The server program 501B is a program for causing the server processing section 200s to implement the functions as the game management section 210B.

The distribution client program 503B is an original of a client program to be downloaded by the player terminal 1500B.

The play data 700s includes game progress management data 710, involved situation registration data 730, involved situation management data 750B, and terminal-specific image management data 780. Although the involved situation management data 750B corresponds to the involved situation management data 750 (see FIG. 12) in the first embodiment, the special game space management data 760 is omitted.

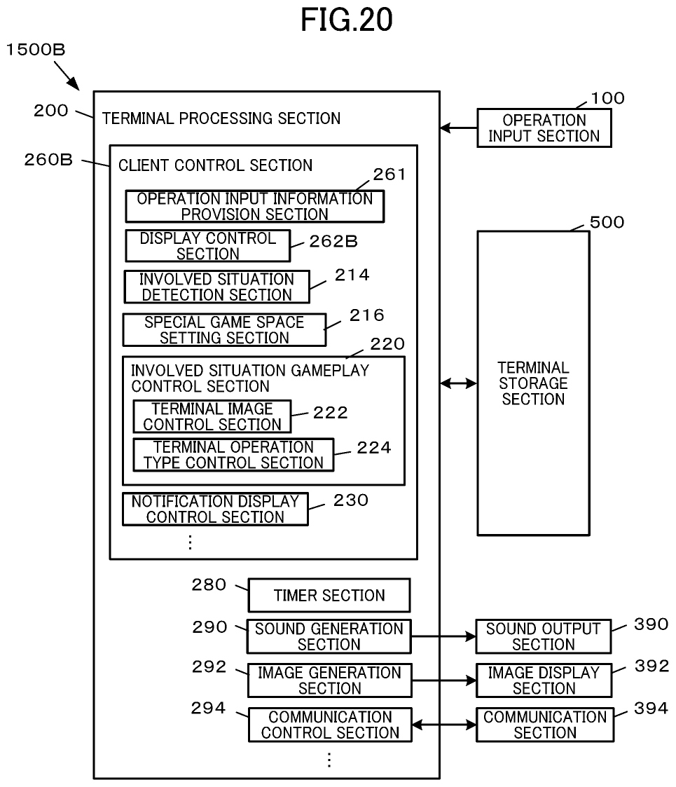

FIG. 20 is a functional block diagram illustrating a functional configuration example of the player terminal 1500B.

The player terminal 1500B includes a client control section 260B. The client control section 260B includes an operation input information provision section 261, a display control section 262B, a special game space setting section 216, an involved situation gameplay control section 220, and a notification display control section 230.

Although the display control section 262B corresponds to the display control section 262 in the first embodiment, the display control section 262B also performs control related to rendering of the game space image 12 and the generation of the gameplay image 14.

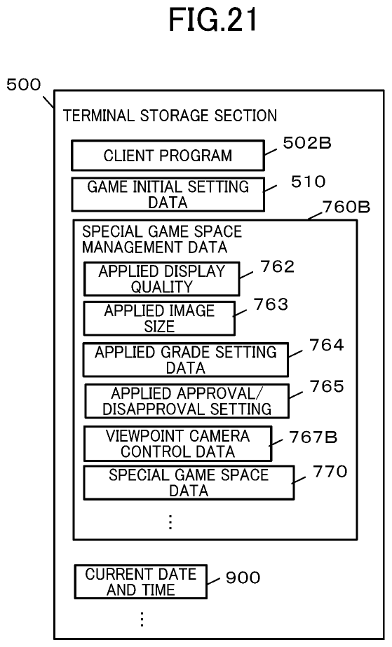

The terminal storage section 500 of the player terminal 1500B stores, as shown in FIG. 21, a client program 502B, game initial setting data 510, special game space management data 760B, and a current date and time 900.

The client program 502B is a program for causing the terminal processing section 200 to implement the functions as the client control section 260B.

The game initial setting data 510 is downloaded from the server system 1100B before the game starts.

The special game space management data 760B includes an applied display quality 762, an applied image size 763, applied grade setting data 764, an applied approval/disapproval setting 765, viewpoint camera control data 767B, and special game space data 770.

The applied approval/disapproval setting 765 is a copy of the approval/disapproval setting 609 (see FIG. 10) of the player who uses the relevant player terminal 1500B.

The viewpoint camera control data 767B is control data of a viewpoint camera of the player terminal 1500B set in the special game space 10 of the relevant management data.

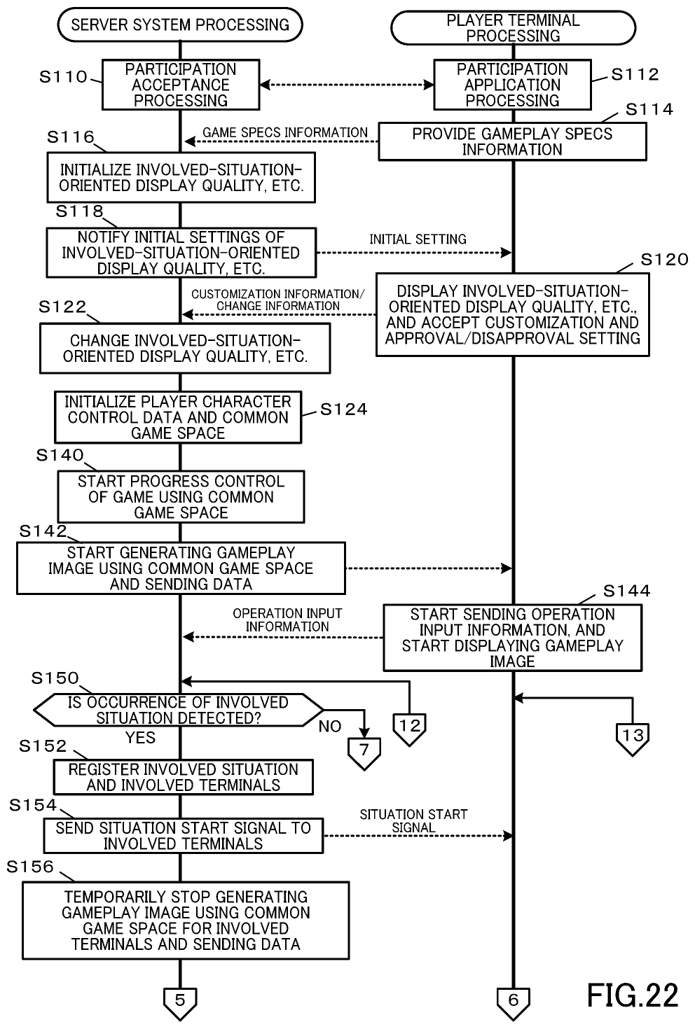

FIGS. 22 to 24 are a flowchart illustrating operation of the game system 1000B according to the present embodiment, and flows of processing performed by the server system 1100B and the player terminal 1500B.

As shown in FIG. 22, the server system 1100B performs processing of accepting participation (step S110). The player terminal 1500B performs processing of applying for participation (step S112).

The player terminal 1500B that has applied for the participation provides the gameplay specs information 605 (see FIG. 10) for the server system 1100B (step S114).

The server system 1100B initializes the involved-situation-oriented display quality 606, the involved-situation-oriented grade setting data 608, the approval/disapproval setting 609 (see FIG. 10) of each of the player terminals 1500B based on the acquired gameplay specs information 605 (step S116), and notifies these initial settings to each of the player terminals 1500B (step S118).

The player terminal 1500B displays these initial settings, accepts customization operation, and sends a customization result to the server system 1100B (step S120). The server system 1100B changes the involved-situation-oriented display quality 606, the involved-situation-oriented grade setting data 608, and the approval/disapproval setting 609 of the player terminal 1500B of a sender according to the customization result (step S122).

Next, the server system 1100B initializes the player character management data 711 and the viewpoint camera control data 722 (see FIG. 11), and initially arranges various types of objects such as the player character 4 in the common game space 8 (step S124). Accordingly, the common game space data 720 is initially set with position information or the like such as the vertex data or polygons of the various types of the objects.

Next, the server system 1100B starts the game progress control of the asynchronous game using the common game space 8 (step S140), and starts generating and sending the data of the gameplay image 14 (game space image data or compressed data thereof) for each of the player terminals 1500B (step S142). That is, the server system 1100B renders the game space image 12 of the common game space 8 for each of the player terminals 1500B, and generates the gameplay image 14 including the rendered game space image 12. The gameplay image 14 at this stage is not based on the special game space 10, and thus the notification display 16 is not included.

In response to the start of the game progress, the player terminal 1500B constantly sends the operation input information (or operation command information reflected from the operation input) to the server system 1100B, and displays the gameplay image 14 on a display of its own based on the received data for displaying the gameplay image 14 (step S144).

The server system 1100B monitors the occurrence of the involved situations after starting the game progress control. When the server system 1100B detects the occurrence of the involved situation (YES at a step S150), the server system 1100B registers the involved situation and the involved terminals (step S152), and sends a situation start signal to each of the involved terminals in the involved situation (step S154).

The “situation start signal” includes, in relation to the player terminal 1500B (involved terminal) of a recipient, the involved-situation-oriented display quality 606, the involved-situation-oriented image size 607, the involved-situation-oriented grade setting data 608, the approval/disapproval setting 609 (see FIG. 10), various types of information (part or all of the player character management data 711 [see FIG. 11], hereinafter referred to as “involved character information”) indicating a latest state of the player character 4, and the viewpoint camera control data 722.

Then, the server system 1100B temporarily stops generating the gameplay image 14 of the asynchronous game using the common game space 8 for each of the involved terminals in the newly detected involved situation, and sending the data for displaying the gameplay image 14 to each of the involved terminals (step S156).

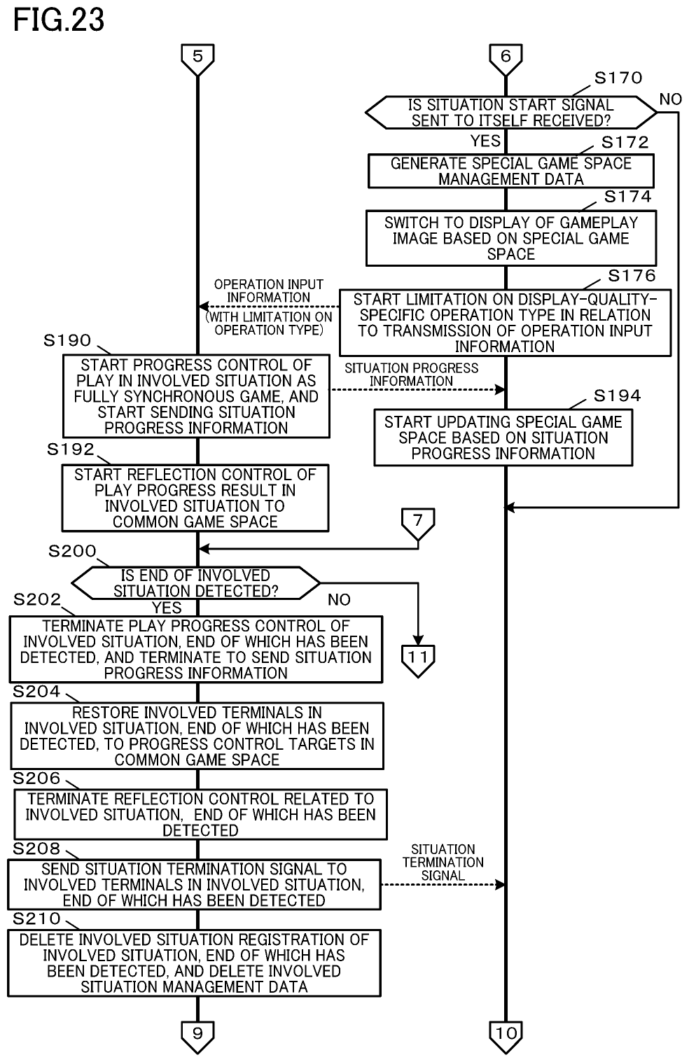

Referring to FIG. 23, when the player terminal 1500B receives the situation start signal from the server system 1100B (YES at a step S170), the player terminal 1500B generates the special game space management data 760B (step S172). In particular, the player terminal 1500B sets the applied display quality 762, the applied image size 763, the applied grade setting data 764, and the applied approval/disapproval setting 765 based on the situation start signal. The player terminal 1500B disposes the various types of object models, such as the player character 4 that has entered the involved situation, with the grade indicated by the applied grade setting data 764 at a position and in a state indicated by the involved character information in the special game space data 770.

After generating the special game space management data 760B, the player terminal 1500B starts generating and displaying the gameplay image 14 based on the special game space 10, and switches the display from the gameplay image 14 of the asynchronous game using the common game space 8 sent from the server system 1100B to the gameplay image 14 based on the special game space 10 (step S174).

In particular, the player terminal 1500B renders the game space image 12 of the special game space 10 represented by the special game space data 770 seen from the viewpoint camera indicated by the viewpoint camera control data 767B in the applied image size 763. Then, the player terminal 1500B generates the gameplay image 14 including the game space image 12 and the notification display 16 corresponding to the display quality indicated by the applied display quality 762, and displays the image on the display of its own.

Furthermore, after generating the special game space management data 760B, in the control for constantly sending the operation input information to the server system 1100B, the player terminal 1500B applies the display-quality-specific operation type data 525 (see FIG. 8) that matches the applied display quality 762 (step S176). In particular, even if the operation input is made by the player, the player terminal 1500B considers it invalid if it is the operation other than operation commands allowed by the matching display-quality-specific operation type data 525, and does not send the operation input information to the server system 1100B.

Meanwhile, when the server system 1100 detects the occurrence of the involved situation, the server system 1100 starts involved situation play progress control as the fully synchronous game, and starts the control for sending “situation progress information” to each of the involved terminals in the involved situation each time when the server system 1100B updates the involved-situation-oriented player character management data 754 due to the progress control of the fighting play (step S190).

The “situation progress information” is information on update content of the involved-situation-oriented player character management data 754. For example, the situation progress information includes travelling, a start of a motion, an end of a motion, and a change of an ability parameter value of the player character 4, information on newly disposed objects (e.g., an NPC 6, or effect objects such as flashes or explosive smoke), or information on objects to be deleted.

The reinforcement of the ability based on the display-quality-specific reinforcement setting data 526 (see FIG. 8) is applied at the start of the progress control of the fighting play.

Furthermore, at the same time as starting the involved situation play progress control, the server system 1100B starts control for reflecting a progress result of the involved situation to the common game space 8 (step S192).

On the other hand, along with generation of the involved situation management data 750, the player terminal 1500B starts control for updating the special game space data 770 based on the situation progress information (step S194). Accordingly, since the player terminal 1500B updates the special game space data 770 based on the situation progress information each time when the player terminal 1500B receives the information from the server system 1100B, content of the special game space 10 of the involved terminal maintains a consistent state with a latest play progress status of the involved situation.

The server system 1100B is monitoring the end of the involved situation that has occurred while performing the game progress control of the asynchronous game using the common game space 8.

When the server system 1100B detects the end of the involved situation (YES at a step S200), the server system 1100B stops the involved situation play progress control of the involved situation the end of which has been detected, and also stops sending involved situation update information to the involved terminals in the involved situation the end of which has been detected (step S202).

Next, the server system 1100B restores the involved terminals in the involved situation the end of which has been detected as control targets of the asynchronous game using the common game space 8 (step S204), and terminates the reflection control related to the involved situation the end of which has been detected to the common game space 8 (step S206). Then, the server system 1100B sends a predetermined situation termination signal to the involved terminals in the involved situation the end of which has been detected (step S208).

Then, the server system 1100B deletes the involved situation registration data 730 and the involved situation management data 750B of the involved situation the end of which has been detected (step S210).

Along with termination of the play control of the fully synchronous game and restoration of the involved terminals as the control targets of the asynchronous game, the server system 1100B reflects content of the involved-situation-oriented player character management data 754 (a last state in the involved situation the end of which has been detected) to the player character management data 711 (see FIG. 11) of the game progress management data 710. At this time, the server system 1100B also terminates a reinforcement amount of the ability parameter value.

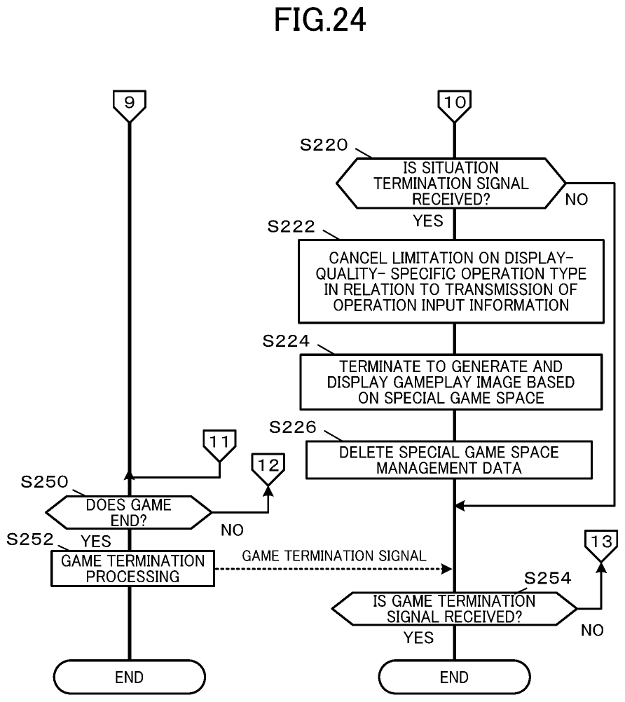

Referring to FIG. 24, when the player terminal 1500B receives the situation termination signal (YES at a step S220), the player terminal 1500B cancels a limitation on the display-quality-specific operation type in relation to the transmission of the operation input information to the server system 1100B (step S222). The player terminal 1500B terminates to generate and display the gameplay image 14 based on the special game space 10 (step S224), and deletes the involved situation management data 750 (step S226).

Meanwhile, the server system 1100B is monitoring whether the end condition of the game is satisfied after starting the asynchronous game using the common game space 8. When the end condition is satisfied (YES at a step S250), the server system 1100B performs the game termination processing, sends a game termination signal to the player terminals 1500B (step S252), and terminates the series of processing.

When the player terminal 1500B receives the game termination signal (YES at a step S254), the player terminal 1500B terminates the series of processing.

As described above, the present embodiment can provide the same advantageous effects as those of the first embodiment, and a load related to the server system 1100B can be distributed to the player terminals 1500B.

### MODIFICATION EXAMPLES

Examples of the embodiments to which the present disclosure is applied have been described so far. Note that the present disclosure is not limited to the foregoing embodiments. Various modifications may be made as appropriate, such as adding other elements, omitting some of the elements, or changing some of the elements.

### Modification Example 1

In the embodiments described above, the MMO game is presented as an example. However, a present embodiment can be applied to an online game other than the MMO game, that is, a multi-play online game that does not include enough players to be called the MMO game.

Game content is not limited to the battle royale fighting action game, and may be set as appropriate. A definition of the involved situation may be set as appropriate depending on the game content. For example, the involved situation in the above-described embodiments is defined as an event involving the plurality of player characters 4. However, the occurrence of the involved situation may be detected in relation to a single player character 4.

### Modification Example 2

In the embodiments described above, the game system 1000 (1000B) is presented as the C/S type system. However, the present disclosure is not limited to this. For example, it is possible to adopt a configuration where the game system omits the server system 1100 and is carried out as a P2P system by a peer-to-peer connection between the player terminals 1500B, and one or some of the player terminals 1500 have functions of the server system 1100.

### Modification Example 3

In the embodiments described above, it is possible to adopt a configuration where the game progress control (game progress control of the asynchronous game using the common game space 8 and the fully synchronous game using the special game space 10) performed by the server system 1100 or the server system 1100B is performed by one or some of the player terminals 1500. That is, in this configuration, the server system 1100 performs acceptance of participation, centralized management of the user registration data 600, and data relay processing between the player terminals 1500. The player terminal 1500 in this configuration includes the game management section 210 in the first embodiment.

### Modification Example 4

It is possible to adopt a configuration, with the game system 1000B in the second embodiment as a base, where the server system 1100B does not generate the gameplay image 14 of the game using the common game space 8 or the gameplay image 14 related to the involved-situation play using the special game space 10, and the player terminals 1500B generate them.

In this case, although the server system 1100B stores the game progress management data 710, the game progress management data 710 omits the common game space data 720, the viewpoint camera control data 722 of its own, and simplified reflection display control data 724. Instead, each of the player terminals 1500B stores the common game space data 720, the viewpoint camera control data 722 of its own, and the simplified reflection display control data 724 of the game progress management data 710 (see FIG. 11).

Then, the server system 1100B distributes progress information indicating the progress control result of the asynchronous game using the common game space 8 to each of the player terminals 1500B. Each of the player terminals 1500B updates the common game space data 720, the viewpoint camera control data 722 of its own, and the simplified reflection display control data 724 that each of the player terminals 1500B stores based on the progress information. Then, each of the player terminals 1500B generates and displays the gameplay image 14 of the common game space 8 based on the common game space data 720.

### Modification Example 5

Information for describing the gameplay specs can be set as appropriate.

For example, the information may include only the device model. In this case, in the step S44, when the server system detects the occurrence of the event of the involved situation, the server system determines the device models of the player terminals 1500 involved in the event. Then, in the step S46, when a number of types of the device models is one, one special game space 10 is shared to reduce a process load.

### Modification example 6

It is possible to adopt a configuration where the reinforcement in the embodiments described above is performed for a limited time period. For example, the time period may be limited to a predetermined time period on a calendar.

Although only some embodiments of the present invention have been described in detail above, those skilled in the art will readily appreciate that many modifications are possible in the embodiments without materially departing from the novel teachings and advantages of this invention. Accordingly, all such modifications are intended to be included within scope of this invention.

1. A computer system comprising at least one processor or circuit comprising:
a common game space setting section configured to set a common game space that can be shared by a plurality of player characters including a first player character related to a first player terminal and a second player character related to a second player terminal having gameplay specs inferior to gameplay specs of the first player terminal;
an involved situation detection section configured to detect that the first player character and the second player character have entered a given involved situation in the common game space; and
a gameplay control section configured to perform first gameplay control set according to the gameplay specs of the first player terminal to the first player terminal and second gameplay control set according to the gameplay specs of the second player terminal to the second player terminal upon detection by the involved situation detection section.

2. The computer system as defined in claim 1,
wherein the at least one processor or circuit further comprises a special game space setting section configured to set a special game space where the first player character and the second player character can exist upon the detection by the involved situation detection section, and
wherein the gameplay control section performs the first gameplay control in the special game space to the first player terminal and the second gameplay control in the special game space to the second player terminal upon the detection by the involved situation detection section.

3. The computer system as defined in claim 2, wherein the special game space setting section sets the special game space in the common game space such that a player character existing outside the special game space can see the special game space.

4. The computer system as defined in claim 1, wherein the involved situation is a situation where the first player character and the second player character satisfy a given encounter condition in the common game space.

5. The computer system as defined in claim 1, wherein the gameplay control section performs control for restoring gameplay control before the detection from the gameplay control according to the detection when a given end condition is satisfied after the detection by the involved situation detection section.

6. The computer system as defined in claim 1,
wherein the gameplay control includes controlling a display quality of a game image on each of the player terminals, and
wherein the gameplay control section includes a terminal image control section configured to perform first terminal image control for making the game image on the first player terminal have a first display quality, and second terminal image control for making the game image on the second player terminal have a second display quality that is inferior to the first display quality upon the detection by the involved situation detection section.

7. The computer system as defined in claim 6,
wherein the gameplay control includes controlling an object displayed in the game image on each of the player terminals, and
wherein the terminal image control section performs
the first terminal image control for making a class of the object displayed in the game image on the first player terminal a first class, and
the second terminal image control for making the class of the object displayed in the game image on the second player terminal a second class that is inferior to the first class in quality.

8. The computer system as defined in claim 1,
wherein the gameplay control includes controlling an allowed operation input type on each of the player terminals, and
wherein the gameplay control section includes a terminal operation type control section configured to perform first terminal operation type control for making the allowed operation input type on the first player terminal a first operation type, and a second terminal operation type control for making the allowed operation input type on the second player terminal a second operation type that includes a fewer number of operation input types than the first operation type, upon the detection by the involved situation detection section.

9. The computer system as defined in claim 1,
wherein the plurality of player characters that share the common game space include a third player character related to a third player terminal having the gameplay specs inferior to the gameplay specs of the second player terminal,
wherein the involved situation detection section detects that the first player character and the third player character have entered the involved situation, and
wherein, upon the detection of the involved situation between the first player character and the third player character by the involved situation detection section, the gameplay control section performs third gameplay control set according to the gameplay specs of the third player terminal to the third player terminal.

10. The computer system as defined in claim 1, wherein the at least one processor or circuit further comprises a notification display control section configured to make notification performed on each of the player terminals related to the player characters detected by the involved situation detection section to notify that the gameplay control according to the detection is performed.

11. The computer system as defined in claim 1, wherein the at least one processor or circuit further comprises a reinforcement control processing section configured to perform reinforcement control processing of enhancing a parameter value of the second player character when the gameplay control according to the detection by the involved situation detection section is performed by the gameplay control section.

12. The computer system as defined in claim 1,
wherein the at least one processor or circuit further comprises a storage section configured to store a setting of approval/disapproval of switching to the second gameplay control as an individual setting of each of the player terminals, and
wherein the gameplay control section performs the first gameplay control to the second player terminal when the setting of the approval/disapproval related to the second player terminal is a setting indicating the disapproval.

13. The computer system as defined in claim 1, wherein the gameplay control includes
control for sending data required for generating a gameplay image to each of the player terminals to have the gameplay image generated on the player terminal, and
control for sending the gameplay image generated on the computer system to each of the player terminals to have the gameplay image displayed on the player terminal.

14. The computer system as defined in claim 1, wherein the gameplay control includes control for sending data required for generating a gameplay image to each of the player terminals to have the gameplay image generated on the player terminal.

15. A game system wherein the computer system as defined in claim 1 and the player terminals are configured to communicate with each other.

16. A player terminal configured to communicate with a computer system that provides an online game that a player operates a player character using the player terminal to enjoy gameplay in a common game space,
wherein the player terminal may become any one of a first player terminal having relatively high gameplay specs and a second player terminal having relatively low gameplay specs,
wherein the computer system comprises
an involved situation detection section configured to detect that a first player character related to the first player terminal and a second player character related to the second player terminal have entered a given involved situation in the common game space, and
a gameplay control section configured to perform first gameplay control set according to the gameplay specs of the first player terminal to the first player terminal and second gameplay control set according to the gameplay specs of the second player terminal to the second player terminal upon detection by the involved situation detection section, and
wherein the player terminal performs control for generating and displaying a gameplay image based on data required for generating the gameplay image received from the computer system.

17. A game execution control method executed by a computer system, the method comprising:
setting a common game space that can be shared by a plurality of player characters including a first player character related to a first player terminal and a second player character related to a second player terminal having gameplay specs inferior to gameplay specs of the first player terminal;
detecting that the first player character and the second player character have entered a given involved situation in the common game space; and
performing first gameplay control set according to the gameplay specs of the first player terminal to the first player terminal and second gameplay control set according to the gameplay specs of the second player terminal to the second player terminal upon detection of the involved situation.
